(19) United States
(12) Patent Application Publication
(10) Pub. No.: US 2025/0374107 A1
(43) Pub. Date: Dec. 4, 2025

(54) DYNAMIC ADAPTATION OF SPATIAL ELEMENTS

(71) Applicant: Fraunhofer-Gesellschaft zur Förderung der angewandten Forschung e.V., München (DE)

(72) Inventors: Geordie GEORGE, Erlangen (DE); Gustavo Wagner OLIVEIRA DA COSTA, Erlangen (DE); Nazanin VATANIAN, Erlangen (DE); Elke ROTH-MANDUTZ, Erlangen (DE); Sutharshun VARATHARAAJAN, Erlangen (DE)

(21) Appl. No.: 19/300,091

(22) Filed: Aug. 14, 2025

Related U.S. Application Data
(63) Continuation of application No. PCT/EP2024/053767, filed on Feb. 14, 2024.

(30) Foreign Application Priority Data
Feb. 15, 2023 (EP) 23156922.9

(51) Int. Cl. H04W 24/10; H04L 5/00

(52) U.S. Cl. CPC H04W 24/10; H04L 5/0048

(57) ABSTRACT

An embodiment of aspect 1 provides an user device, UE, for a wireless communication system, wherein the UE or a its transceiver is configured to
receive from a network node, e.g., gNB, at least
   a channel state information, CSI, report configuration via a higher layer, e.g., radio resource control, RRC, layer,
   a configuration or indication via a PHY-layer, e.g., physical downlink control channel, PDCCH, signalling, and/or a higher layer signalling,
perform measurement(s) on said at least one CSI-RS resource,
compute one or more parameters related to a channel state information, CSI, and/or DL transmission rate and/or reliability associated with at least one of the P subsets of a CSI-RS resource, and
transmit a report to the network node via the PHY-layer or a higher layer.

### CROSS-REFERENCE TO RELATED APPLICATIONS

This application is a continuation of copending International Application No. PCT/EP2024/053767, filed Feb. 14, 2024, which is incorporated herein by reference in its entirety, and additionally claims priority from European Application No. 23156922.9, filed Feb. 15, 2023, which is also incorporated herein by reference in its entirety.

### TECHNICAL FIELD

The present disclosure relates to the field of wireless communications, and in particular to methods and apparatuses for Channel State Information (CSI) or beam reporting for wireless devices in a wireless communications network such as advanced 5G networks to enable dynamic adaptation of antenna elements in multi-antenna communications.

### BACKGROUND OF THE INVENTION

The fifth generation (5G) mobile communications system also known as new radio (NR) provides a higher level of performance than the previous generations of mobile communications system. 5G mobile communications has been driven by the need to provide ubiquitous connectivity for applications as diverse automotive communication, remote control with feedback, video downloads, as well as data applications for Internet-of-Things (IoT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

FIG. 1 illustrates a simplified schematic view of an example of a wireless communications network 100 including a core network (CN) 110 and a radio access network (RAN) 120, both linked via the backhaul 111. The RAN 120 is shown including a plurality of network nodes or radio base stations, which in 5G are called gNBs. Three radio base stations are depicted gNB1, gNB2 and gNB3. Each gNB serves an area called a coverage area or a cell. FIG. 1 illustrates 3 cells 121, 122 and 123, each served by its own gNB, gNB1, gNB2 and gNB3, respectively.

It should be mentioned that the network 100 may include any number of cells and gNBs. The radio base stations, or network nodes serve users within a cell. In 4G or LTE, a radio base station is called an eNB, in 3G or UMTS, a radio base station is called an eNodeB, and BS in other radio access technologies. A user or a user equipment (wireless device), UE, may be a wireless or a mobile terminal device or a stationary communication device. A mobile terminal device or a wireless device may also be an IoT device, an MTC device, etc. IoT devices may include wireless sensors, software, actuators, and computer devices. They can be imbedded into mobile devices, motor vehicle, industrial equipment, environmental sensors, medical devices, aerial vehicles and more, as well as network connectivity that enables these devices to collect and exchange data across an existing network infrastructure.

Referring back to FIG. 1, each cell is shown including UEs and IoT devices. gNB1 in cell 121 serves UE1 121A, UE2 121B and IoT device 121C. Similarly, gNB2 in cell 121 serves UE3 122A, UE4 122B and IoT device 122C, and gNB3 in cell 123 serves UE5 123A, UE6 123B and IoT device 123C. The network 100 may include any number of UEs and IoT devices or any other types of devices. The devices communicate with the serving gNB(s) in the uplink and the gNB(s) communicate with the devices in the downlink. The respective base station gNB1 to gNB3 may be connected to the CN 120, e.g., via the S1 interface, via respective backhaul links 111, 121D, 122D, 123D, which are schematically depicted in Error! Reference source not found. by the arrows pointing to “core”. The core network 120 may be connected to one or more external networks, such as the Internet. The gNBs may be connected to each other via the S1 interface or the X2 interface or the XN interface in 5G, via respective interface links 121E, 122E and 123E, which is depicted in the figure by the arrows pointing to gNBs.

For data transmission, a physical resource grid may be used. The physical resource grid may comprise a set of resource elements (REs) to which various physical channels and physical signals are mapped. For example, the physical channels may include the physical downlink, uplink and/or sidelink (SL) shared channels (PDSCH, PUSCH, PSSCH) carrying user specific data, also referred to as downlink, uplink or sidelink payload data, the physical broadcast channel (PBCH) carrying for example a master information block (MIB) and a system information block (SIB), the physical downlink, uplink and/or sidelink control channels (PDCCH, PUCCH, PSCCH) carrying for example the downlink control information (DCI), the uplink control information (UCI) or the sidelink control information (SCI). For the uplink, the physical channels may further include the physical random-access channel (PRACH or RACH) used by UEs for accessing the network once a wireless device is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. IN 5G, each slot consists of 14 OFDM symbols or 12 OFDM symbols based on normal CP and extended CP respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a wireless device whether an OFDM symbol is downlink, uplink or flexible.

The wireless communication network system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

The wireless communications network system depicted in FIG. 1 may be a heterogeneous network having two distinct overlaid networks, a network of macro cells with each macro cell including a macro base station, like base station gNB1 to gNB3, and a network of small cell base stations (not shown in FIG. 1), like femto-or pico-base stations. In addition to the above described wireless network also non-terrestrial wireless communication networks exist including space borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-advanced pro standard or the 5G or NR, standard.

In the wireless communications network system as described above, such as LTE or New Radio (5G), downlink signals convey data signals, control signals containing downlink, DL, control information (DCI), and a number of reference signals or symbols (RS) used for different purposes. A gNodeB (or gNB or base station) transmits data and downlink control information (DCI) through the so-called physical downlink shared channel (PDSCH) and physical downlink control channel (PDCCH) or enhanced PDCCH (ePDCCH), respectively. Moreover, the downlink signal(s) of the gNB may contain one or multiple types of reference signals (RSs) including a common/cell-specific RS (CRS) in LTE, a channel state information RS (CSI-RS), synchronization signals, a demodulation RS (DM-RS), and a phase tracking RS (PT-RS). The CRS is transmitted over a DL system bandwidth part and used at the user equipment (wireless device) to obtain a channel estimate to demodulate the data or control information. The CSI-RS is transmitted with a reduced density in the time and frequency domain compared to CRS and used at the wireless device for channel estimation or for channel state information (CSI) acquisition. The synchronization signals (SS) which can be further classified into primary and secondary synchronization signals (PSS/SSS) are transmitted along with the physical broadcast channel (PBCH) as a SS/PBCH block or a SS block (SSB). The SSs or the SSBs as a whole are used for frame synchronization in the DL, cell selection, initial access and/or beam management, among other purposes. The DM-RS is transmitted along with the PDSCH, PDCCH and/or PBCH, which is then used by the wireless device for data demodulation.

A wireless communications network system may operate in either or both carrier frequency ranges 1 and/or 2, i.e., FR1 and/or FR2, which are defined in [1]. FR1 corresponds to a lower range of carrier frequency (typically less than 6 GHZ) and FR2 to a higher range of carrier frequencies. A network system may operate some of the physical channels in FR1 and other in FR2, or all the physical channels are operated completely either in FR1 or FR2.

In the wireless communications network system such as the one depicted schematically in FIG. 1, multi-antenna techniques may be used, e.g., in accordance with LTE, NR or any other communication system, to improve user data rates, link reliability, cell coverage and network capacity. Conventional approaches are not optimal with respect to dynamic adaptation of the antenna array elements.

It is an objective of the present invention to improve and/or enable dynamic adaptation of the antenna array elements of a transceiver.

### SUMMARY

An embodiment may have a user device, UE, for a wireless communication system, wherein the UE is configured to
receive from a network node, e.g., gNB, at least
   a channel state information, CSI, report configuration via a higher layer, e.g., radio resource control, RRO, layer, wherein the CSI report configuration provides at least one CSI reference signal, CSI-RS, resource comprising N>1 ports for measurement by the UE,
   a configuration or indication via a PHY-layer, g., physical downlink control channel, PDOCH, signalling, or a higher layer, e.g., ARC or medium access control, MAC, layer signalling, P≥1 subset(s) of spatial domain resource(s) or parameter(s) related to them, associated with at least one of the CSI-RS resources provided by the CSI report configuration, perform measurement(s) on said at least one CSI-RS resource provided by the CSI report configuration,
compute one or more parameters related to a channel state information, CSI, or DL transmission rate or reliability associated with at least one of the P subsets of a CSI-RS resource configured or indicated by the network node, and
transmit a report to the network node via the PHY-layer or a higher layer, the report comprising at least one or more of said computed one or more parameter(s), which is/are associated with at least one of the P subsets of a CSI-RS resource configured or indicated by the network node.

Another embodiment may have a network node for a wireless communication system, the wireless communication system comprising one or more user devices, UEs, wherein the network node is configured to
a. transmit to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration, and
enable the UE to
   perform measurements on said at least one CSI-RS resource provided by the CSI report configuration,
   compute one or more parameters related to a channel state information, CSI, or DL transmission rate or reliability associated with at least one of the P subsets of a CSI-RS resource configured or indicated by the network node, and.
receive from the UE, a report via the PHY-layer or a higher layer, the report comprising at least one or more of said computed one or more parameter(s) which is/are associated with at least one of the P subsets of a CSI-RS resource configured or indicated by the network node.

Another embodiment may have a method for operating a user device, UE, for a wireless communication system, the method having the steps of:
receiving from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration,
performing measurements on said at least one CSI-RS resource provided by the CSI report configuration,
computing one or more parameters related to a channel state information, CSI, or DL transmission rate or reliability associated with at least one of the P subsets of a CSI-RS resource configured or indicated by the network node, and
transmitting a report to the network node via the PHY-layer or a higher layer, the report comprising at least one or more of the computed parameter(s) associated with at least one of the P subsets of a CSI-RS resource configured or indicated by the network node.

Another embodiment may have a method for operating a network node for a wireless communication system, the wireless communication system comprising one or more user devices, UEs, the method having the steps of:
b. transmitting to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration, and
enabling the UE to
   perform measurements on said at least one CSI-RS resource provided by the CSI report configuration,
   compute one or more parameters related to a channel state information, CSI, or DL transmission rate or reliability associated with at least one of the P subsets of a CSI-RS resource configured or indicated by the network node, and
receiving from the UE, a report via the PHY-layer or a higher layer, the report comprising at least one or more of the computed parameter(s) associated with at least one of the P subsets of a CSI-RS resource configured or indicated by the network node.

Still another embodiment may have a non-transitory digital storage medium having a computer program stored thereon to perform the above method according to the invention when the computer program is run by a computer.

It is a further objective of the embodiments herein to provide methods and apparatuses for CSI or beam reporting in a wireless communications network such as advanced 5G networks that can aid in dynamic adaptation of the antenna array elements used in transmission and/or reception, thereby aiding in energy saving at networks and/or wireless devices.

An embodiment of aspect 1 provides a user device, UE, for a wireless communication system, wherein the UE or its transceiver is configured to
receive from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P>1 subset(s) of time, frequency and/or spatial domain resource(s) and/or parameter(s) related to them, associated with at least one of the CSI-RS resources provided by the CSI report configuration,
perform measurement(s) on said at least one CSI-RS resource provided by the CSI report configuration,
compute one or more parameters related to a channel state information, CSI, and/or DL transmission rate and/or reliability associated with at least one of the P subsets of a CSI-RS resource configured or indicated by the network node, and. transmit a report to the network node via the PHY-layer or a higher layer, the report
comprising at least one or more of said computed one or more parameter(s), which is/are associated with at least one of the P subsets of a CSI-RS resource configured or indicated by the network node.

Another embodiment provides a network node for a wireless communication system, the wireless communication system comprising one or more user devices, UEs, wherein the network node or its transceiver is configured to
transmit to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the CSI report configuration, and
enable the UE to
   perform measurements on said at least one CSI-RS resource provided by the CSI report configuration,
   compute one or more parameters related to a channel state information, CSI, and/or DL transmission rate and/or reliability associated with at least one of the P subsets of a CSI-RS resource configured or indicated by the network node, and
receive from the UE, a report via the PHY-layer or a higher layer, the report comprising at least one or more of said computed one or more parameter(s) which is/are associated with at least one of the P subsets of a CSI-RS resource configured or indicated by the network node.

An embodiment of aspect 2 provides a user device, UE, for a wireless communication system, wherein the UE or its transceiver is configured to
receive at least a CSI report configuration from a network node via a higher layer, wherein the CSI report configuration at least provides two or more CSI-RS resources for channel measurement by the wireless device wherein each CSI-RS resource is configured with one or more ports,
perform measurements on at least one or two of said CSI-RS resources,
compute one or more parameters related to a channel state information, CSI, and/or DL transmission rate and/or reliability associated with at least one of said CSI-RS resources, and
transmit a report to the network node via the PHY-layer or a higher layer, the report comprising at least one or more of said computed parameters associated with at least one of said CSI-RS resources.

Another embodiment provides a network node for a wireless communication system, the wireless communication system comprising one or more user devices, UEs, wherein the network node or its transceiver is configured to
transmit to a UE at least a CSI report configuration from a network node via a higher layer, wherein the CSI report configuration at least provides two or more CSI-RS resources for channel measurement by the wireless device wherein each CSI-RS resource is configured with one or more ports, and
enable the UE to
   perform measurements on at least one or two of said CSI-RS resources, and
   compute one or more parameters related to a channel state information, CSI, and/or DL transmission rate and/or reliability associated with at least one of said CSI-RS resources, and
receive from the UE, a report via the PHY-layer or a higher layer, the report comprising at least one or more of said computed parameters associated with at least one of said CSI-RS resources.

An embodiment of aspect 3 provides a user device, UE, for a wireless communication system, wherein the UE or its transceiver is configured to
receive at least a CSI report configuration from a network node via a higher layer, wherein the CSI report configuration at least provides W≥2 CSI-RS and/or SSB resources for channel measurement by the wireless device,
perform measurements on at least one of said resources, and
report the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

Another embodiment provides a network node for a wireless communication system, the wireless communication system comprising one or more user devices, UEs, wherein the network node or its transceiver is configured to.
transmit to the UE at least a CSI report configuration from a network node via a higher layer, wherein the CSI report configuration at least provides W≥2 CSI-RS and/or SSB resources for channel measurement by the wireless device, and
enable the UE to perform measurements on at least one of said resources, and
receive from the UE, a report of the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

According to embodiments, the UE uses different spatial receive filters or is indicated with different, transmission configuration indication, TCI, states, to receive and/or measure at least two different RSs among the L reported RSs.

According to embodiments, M>1 subsets of said W>M CSI-RS resources are present, wherein the wireless device shall transmit to a network node in a report, one or more index (indices)/indicator(s)/identifier(s) of CSI-RS resources, and one or more parameters related to RSRP or SINR measurements associated with said subset(s), wherein
at least one resource from each subset is provided in the report, or
at least two of the resources provided in the report belong to two different subsets.

According to embodiments, said grouping of the W CSI-RS resource(s) into M subsets is performed by the UE or network node or is a fixed method in the specifications, based on one or more common properties among the subsets.

According to embodiments, the UE is configured to report to the network node, via the PHY-layer and/or a higher layer, the index/indicator/identifier of L=1 CSI-RS or SSB resource, wherein the reported resource is one of the following:
resource with the best L1-RSRP/SINR, among the W resources configured for measurement, or
resource with the lowest L1-RSRP/SINR that is above a configured or predetermined/fixed threshold t, among the W resources configured for measurement.

According to embodiments, the UE is configured to report to the network node, via the PHY-layer and/or a higher layer, indices/indicators/identifiers of L≥2 CSI-RS or SSB resources, wherein the reported resources may be one of the following:
Z resource(s) with the highest and L-Z resource(s) with the lowest L1-RSRP/SINR, among the W resources configured for measurement, where 1 ≤ Z <L, or
Z resource(s) with the highest L1-RSRP/SINR and L-Z resource(s) with the lowest L1-RSRP/SINR that is above a configured or predetermined/fixed threshold t, among the W resources configured for measurement, where 1≤Z<L.

An embodiment of aspect 4 provides a user device, UE, for a wireless communication system, wherein the UE or its transceiver is configured by the network to transmit K UL RSs, e.g., sounding reference signals, SRSs, for beam management, wherein.
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network.

Another embodiment provides anetwork node for a wireless communication system, the wireless communication system comprising one or more user devices, UEs, wherein the network node or its transceiver is to configure a UE to transmit K UL RSs, e.g., sounding reference signals, SRSs, for beam management, wherein
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network node.

According to embodiments, the network schedules repetition of an SRS beam in order to sweep its Rx beams.

According to embodiments, the receive beams correspond to different sets of antenna elements and/or spatial directions.

An embodiment provides a system comprising a base station/network node and one or more respect UEs according to the above aspects.

These aspects may be implemented as methods.

An embodiment provides a method for operating a user device, UE, for a wireless communication system, the method comprising
receiving from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P>1 subset(s) of time, frequency and/or spatial domain resource(s) and/or parameter(s) related to them, associated with at least one of the CSI-RS resources provided by the CSI report configuration,
performing measurements on said at least one CSI-RS resource provided by the CSI report configuration,
computing one or more parameters related to a channel state information, CSI, and/or DL transmission rate and/or reliability associated with at least one of the P subsets of a CSI-RS resource configured or indicated by the network node, and
transmitting a report to the network node via the PHY-layer or a higher layer, the report comprising at least one or more of the computed parameter(s) associated with at least one of the P subsets of a CSI-RS resource configured or indicated by the network node.

An embodiment provides a method for operating a user device, UE, for a wireless communication system, the method comprising
receiving at least a channel state information CSI report configuration from a network node via a higher layer, wherein the CSI report configuration at least provides two or more CSI-RS resources for channel measurement by the wireless device wherein each CSI-RS resource is configured with one or more ports,
performing measurements on at least one of said CSI-RS resources,
computing one or more parameters related to a channel state information, CSI, and/or DL transmission rate and/or reliability associated with at least one of said CSI-RS resources, and
transmitting a report to the network node via the PHY-layer or a higher layer, the report comprising at least one or more of said computed one or more parameters which is/are associated with at least one of said CSI-RS resources.

An embodiment provides a method for operating a user device, UE, for a wireless communication system, the method comprising:
receiving at least a CSI report configuration from a network node via a higher layer, wherein the CSI report configuration at least provides W≥2 CSI-RS and/or SSB resources for channel measurement by the wireless device,
performing measurements on at least one of said resources, and
reporting the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

An embodiment provides a method for operating a user device, UE, for a wireless communication system, the method comprising, receiving configuration from the network to transmit K UL RSs, e.g., sounding reference signals, SRSs, for beam management, wherein
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network.

An embodiment provides a method for operating a network node for a wireless communication system, the wireless communication system comprising one or more user devices, UEs, the method comprising
transmitting to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the CSI report configuration, and
enabling the UE to
   perform measurements on said at least one CSI-RS resource provided by the CSI report configuration,
   compute one or more parameters related to a channel state information, CSI, and/or DL transmission rate and/or reliability associated with at least one of the P subsets of a CSI-RS resource configured or indicated by the network node, and.
receiving from the UE, a report via the PHY-layer or a higher layer, the report comprising at least one or more of the computed parameter(s) associated with at least one of the P subsets of a CSI-RS resource configured or indicated by the network node.

An embodiment provides a method for operating a network node for a wireless communication system, the wireless communication system comprising one or more user devices, UEs, the method comprising
transmitting to a UE at least a channel state information CSI report configuration from a network node via a higher layer, wherein the CSI report configuration at least provides two or more CSI-RS resources for channel measurement by the wireless device wherein each CSI-RS resource is configured with one or more ports, and
enabling the UE to
   perform measurements on at least one of said CSI-RS resources, and
   compute one or more parameters related to a channel state information, CSI, and/or DL transmission rate and/or reliability associated with at least one of said CSI-RS resources, and
receiving from the UE, a report via the PHY-layer or a higher layer, the report comprising at least one or more of said computed parameters associated with at least one of said CSI-RS resources.

An embodiment provides a method for operating a network node for a wireless communication system, the wireless communication system comprising one or more user devices, UEs, the method comprising.
transmitting to the UE at least a CSI report configuration from a network node via a higher layer, wherein the CSI report configuration at least provides W≥2 CSI-RS and/or SSB resources for channel measurement by the wireless device, and
enabling the UE to perform measurements on at least one of said resources, and
receiving from the UE, a report of the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

An embodiment provides a method for operating a network node for a wireless communication system, the wireless communication system comprising one or more user devices, UEs, the method comprising, configuring a UE to transmit K UL RSs, e.g., sounding reference signals, SRSs, for beam management, wherein.
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network node.

The above methods may be computer implemented.

According to an aspect of some embodiments herein, there is provided a method performed by a wireless device.

Below, optional features mainly for aspect 1, but applicable/transferable for aspect 2, 3 and 4 will be discussed:

According to embodiments, the spatial domain resource(s) associated with a CSI-RS resource, is/are the port(s) associated with the CSI-RS resource. According to embodiments, the frequency domain resource(s) associated with a CSI-RS resource, is/are the physical resource block(s) associated with the CSI-RS resource. According to embodiments, the time domain resource(s) associated with a CSI-RS resource, is/are the symbols(s) associated with the CSI-RS resource in a slot/subframe/frame.

According to embodiments, said CSI report configuration provides at least one of the following:
One or more non-zero power (NZP) CSI-RS resources for channel measurement,
One or more zero power (ZP) CSI-RS resources for interference measurement,
One or more CSI-Interference management (CSI-IM) resources for interference measurement,
One or more NZP CSI-RS resources for interference measurement.

According to embodiments, said CSI report configuration provides at least a configuration or indication of P>1 subset(s) of time, frequency and/or spatial domain resource(s) and/or parameter(s) related to them, associated with at least one of the CSI-RS resource(s).

According to embodiments, the network nodes provide to the UE, via the PHY-layer or a higher layer, an indication or configuration of at least one of the following:
a parameter enabling the UE to choose to report a given subset pᵢ among the P subset(s) of a CSI-RS resource along with one or more parameter(s),
a parameter enabling to compute of one or more parameter(s) related to a CSI and/or DL transmission and/or DL transmission rate and/or reliability associated with subset pᵢ, threshold for a parameter related to a CSI, DL transmission rate and/or reliability.

According to embodiments, the network nodes provides to the UE, via the PHY-layer or a higher layer, a configuration or indication of one or more parameter(s) related to a channel state information, CSI, and/or DL transmission rate and/or reliability associated with at least one of the subsets of a CSI-RS resource, that the UE shall measure, compute and/or report.

According to embodiments, the reporting to the network node is performed via the physical uplink control channel, PUCCH, or the physical uplink shared channel, PUSCH.

According to embodiments, one or more parameters related to a CSI and/or DL transmission rate and/or reliability associated with K subsets of the CSI-RS resource, wherein 1≤K≤P; and the value of K is configured by the network node, and/or equal to P, and/or fixed in the specifications.

According to embodiments, the UE is configured to measure, compute and/or report to a network node, at least one of the following parameters associated with one or more of the K subsets associated with a CSI-RS resource:
wideband or subband CQI value(s)
precoding matrix indicator(s) or information related to precoding matrix indicator(s)
rank indicator
layer indicator

According to embodiments, the reporting comprises at least one of the following parameter(s) associated with at least one of the K subsets of a CSI-RS resource, wherein 1≤K≤P:
a performance/measurement metric,
a differential or a relative performance/measurement metric with respect to the same metric computed in association with said CSI-RS resource,
a differential or a relative performance/measurement metric with respect to the same metric computed in association with one of the P subsets associated with said CSI-RS resource.

According to embodiments, the performance/measurement metric and/or the differential/relative performance/measurement metric reported by a wireless device to a network node via the PHY-layer or a higher layer, with respect to one or more subsets associated with a CSI-RS resource is at least one of the following:
a reference signal received power (RSRP) or a differential RSRP,
a signal to interference-plus-noise ratio (SINR) or a differential SINR,
an index/indicator of a modulation and coding scheme (MCS) or a differential MCS index/indicator,
a channel quality indicator/index, CQI, or a differential CQI,
a value/differential value (or an indicator of a value/differential value) of a throughput/spectral efficiency or any other parameter related to a data rate or reliability,
a rank or a differential rank value/indicator,
a BLER or a differential BLER value/indicator

According to embodiments the UE is configured to report to a network node, at least an index/indicator/identifier of a first subset associated with a CSI-RS resource, wherein at least one of the following conditions apply:
the value of said at least one parameter associated with said first subset is greater than (or less than) a predetermined, preconfigured or configured threshold t, the value of said at least one parameter associated with at least one other subset among
the P subsets associated with the CSI-RS resource is greater than (or less than) said threshold t or a different predetermined, preconfigured or configured threshold t′, wherein
   the number/size/dimension of the time, frequency and/or spatial domain resources associated with said first subset is less than that of said at least one other subset, and/or
   the difference/deviation in value of said parameter from the threshold t is higher (or lower) than that of said at least one other subset from its respective threshold, and/or
the index/indicator/identifier of said first subset is higher/lower than that of said at least one other subset.

M>1 groups of said P subsets of a CSI-RS resource are according to embodiments present, wherein the UE shall provide to a network node in a report, one or more parameters related to a CSI and/or DL transmission rate and/or reliability associated with 1≤K≤P subsets of a CSI-RS resource, wherein among the K subset(s), when K≥2
at least two of the subsets belong to two different groups, or
every subset belongs to a different group.

### BRIEF DESCRIPTION OF DRAWINGS

Embodiments of the present invention are now described in further detail with reference to the accompanying drawings, in which:

FIG. 1 shows a schematic representation of a wireless communications system;

FIG. 2 shows a schematic representation of two stage beamforming, involving precoding based on CSI mapping MIMO layers to antenna ports followed by beamforming via beam management;

FIG. 3 shows a typical timeline of CSI measurement and feedback in 3GPP 5G-NR;

FIG. 4 shows a schematic representation of a DL transmission using a codebook-based-precoding scheme;

FIG. 5 shows a schematic representation of a DL transmission using a codebook-based-precoding scheme and analog beamforming;

FIG. 6 shows a time sequence chart of link adaptation involved with a hybrid beamforming array at a network node;

FIG. 7 shows an example of CSI-RS resource and subsets configuration and the association with antenna array ports at a base station;

FIG. 8 shows an example of CSI-RS resource and subsets configuration and the association with antenna array ports at a base station;

FIG. 9 shows an example of using subsets of elements in a physical antenna array in beam management with hybrid beamforming with given number of virtual antenna ports and CS-RS recourse;

FIG. 10 is a block diagram depicting a wireless device according to some embodiments herein; and

FIG. 11 is a block diagram depicting a network node according to some embodiments herein.

### DETAILED DESCRIPTION OF THE INVENTION

In the following, a detailed description of the exemplary embodiments is described in conjunction with the drawings, in several scenarios to enable easier understanding of the solution(s) described herein.

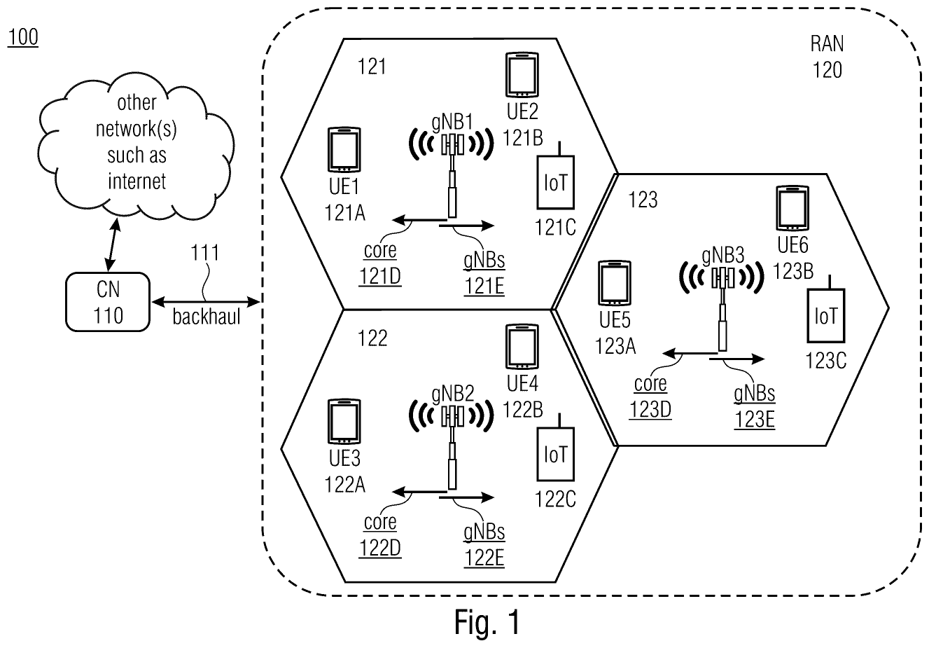

In the wireless communications network system such as the one depicted schematically in FIG. 1, multi-antenna techniques may be used, e.g., in accordance with LTE, NR or any other communication system, to improve user data rates, link reliability, cell coverage and network capacity. Conventional approaches are not optimal with respect to dynamic adaptation of the antenna array elements.

To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct or focus a data transmission towards an intended receiver. The precoder matrix to be used at the gNB to map the data to the transmit antenna ports is decided using channel state information, CSI.

For signal precoding at the gNB, the channel state information is either reported or fed back from a user equipment (wireless device served by the gNB) and/or acquired from measurements of UL channel from reference signals transmitted by the wireless device.

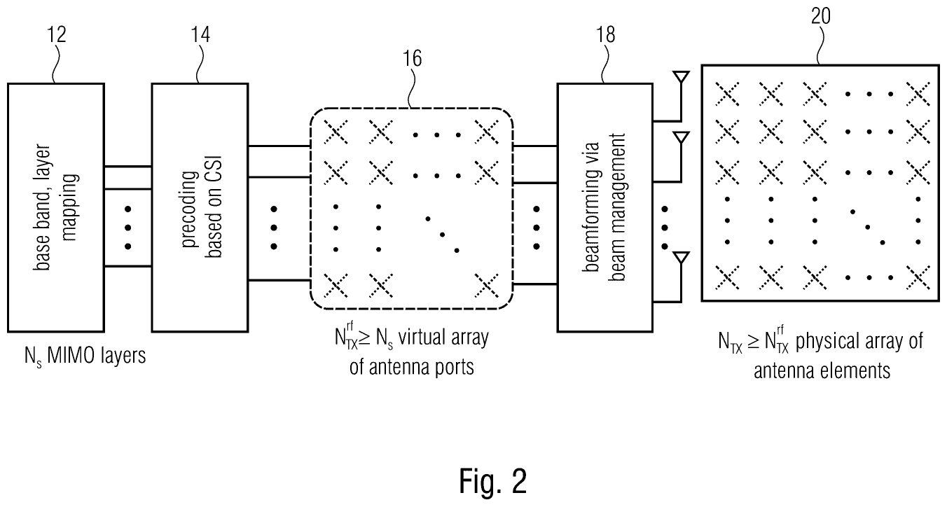

Additionally, or alternatively, to the precoding based on CSI, beamforming without CSI can be performed via beam management procedures (involving step-by-step beam sweeping transmissions, reporting based on measurements done by receiver(s) and beam determination as will be detailed in the following) as depicted in FIG. 2.

FIG. 2 shows a physical antenna array element 20 to be used for beamforming via beam management (cf. block 18). The beam forming via beam management is done first in Ns MIMO layers (cf. blocks 12 and 14) and

$${N}_{T X} \geq {N}_{T X}^{r f}$$

virtual array or antenna ports (block 16).

Networks employing massive antenna arrays 20 for transmission and reception incur a lot of energy due to the numerous power amplifiers and analog beamforming networks involved in operating them. With a major share of the power consumption at the network coming from such arrays, switching to a smaller subset of the antenna array(s) at the network, dynamically, based on user demands, location, position, velocity, traffic conditions and/or scheduling requirements, would help in sustained and adaptive energy saving at the network-side. In this disclosure, various methods for energy savings at the network using the CSI framework and/or beam management are proposed.

The multiple-input-multiple-output (MIMO) framework in a wireless communications network system essentially consists of the mapping of the spatial layer(s) for transmission (for e.g., the layers of PDSCH in the downlink) to a set (array) of antenna ports. The antenna ports are in turn mapped to a set (array) of physical antenna elements. Each stage of mapping may involve spatial precoding and/or beamforming to apply certain desired precoding/beamforming weights. The weights (also referred to as array steering vectors) of the antenna array are amplitude gains and phase adjustments that are applied to the signal fed to the antennas (or the signal received from the antennas) to transmit (or obtain) a radiation towards (or from) a particular direction. Typically, the number of antenna ports is equal to or greater than the number of spatial layers and the number of physical antenna elements is equal to or greater than the number of antenna ports. Beamforming/precoding can be performed in a single stage or two (or more) stages, involving digital beamforming (called precoding in 5G NR) on the digital basedband signal or/and analog beamforming on the analog (RF) signal, i.e., with the possibility of digital-analog hybrid beamforming. Typically, hybrid beamforming is implemented in systems where a few spatial layers are mapped to a much larger number of physical antenna elements, such as FR2 systems. With hybrid beamforming, the number of RF chains needed for each antenna port at the output of the digital precoding stage can be minimized, thereby reducing power consumption at the device or network.

The digital beamforming, or the precoding stage is performed based on the channel state information (CSI) available at the transmitter. In a wireless communications network system employing time division duplexing, TDD, the downlink precoding information can be obtained via uplink measurements at the base station (gNB), if channel reciprocity between the uplink and the downlink is applicable. Some other CSI parameters (modulation order and coding scheme and/or rank to be used) may still be required via a CSI feedback from the wireless device. However, when employing frequency division duplexing, FDD, due to the absence of channel reciprocity (also in some TDD scenarios), the precoding information is computed/estimated at the wireless device and is then fed back to the gNB in a CSI report.

The analog beamforming (if applicable/when beamforming must be chosen from multiple possible analog beams), is performed via beam reporting from the UE. Using beam management procedures such as beam sweeping, refinement and selection in the downlink and/or uplink, which are supported by measurements at the UE and/or gNB, and/or beam reporting by the UE, the UE and gNB determine the pairs of beams to be used for transmission and reception.

The CSI available at the gNB is utilized for several procedures (as detailed later) including spatial precoding (or digital beamforming), which is the mapping from the spatial layers for transmission of the PDSCH to a set of antenna port(s). As indicated, these antenna port(s) are mapped onto the same number or more of physical antenna elements. This step may involve analog beamforming, in some scenarios (typically done on waveform modulated PDSCH signals that has been converted from the discrete-time/digital domain to continuous-time/analog domain). Note that the precoding (or digital beamforming) and the analog beamforming steps constitute the overall beamforming of the transmitted signal, which is called hybrid beamforming in general. The analog beamforming, specifically, can apply further beamforming weights on the precoded (digitally beamformed) signals from the array of antenna ports, in mapping them to the array of antenna elements in order to further shape the antenna gain patterns or beams in desired directions of radiation. The analog beamforming weights may be fixed, e.g., for forming a sectorized antenna gain pattern, which is typically done in FR1 , common to all users being served within an intended coverage area (without requiring explicit beam management procedures). Alternatively, such beamforming weights may be estimated and altered over time so as to form antenna patterns pointed at desired directions where each UE is located, which is typically done in FR2 via beam management procedure as described above.

### Precoding or Digital Beamforming

In various systems, especially in FR1 , only the precoding or digital beamforming is necessary/performed. In such systems, each antenna port may correspond to an antenna element or an analog beamforming is established with fixed wide beams in the gNB and/or UE (which may be enough to cover the entire cell/sector that the network node or the UE needs to cover). Even in system with beam management, once the desired analog beamforming is established, a CSI feedback for the adaptation of the link parameters is required for scheduling data transmissions. The parameters of transmission for the downlink (DL) by a network node to a user equipment (wireless device) can be updated by channel state information (CSI) feedback from the user equipment. The network configures the wireless device with the parameters to be reported in a CSI feedback/CSI reporting occasion by the wireless device. The reference signal (RS) resource(s) to be measured by the wireless device for the CSI feedback or CSI report are provided to the wireless device by the network node or another communication entity. The CSI feedback is transmitted by the wireless device based on the measurements from one or more RSs such as CRSs, SSB(s) or CSI-RS resource(s). Upon reception and subsequent measurement of the DL RS(s), the wireless device typically computes an estimate of the channel information between a network node and itself, in addition to the interference and/or noise information on certain occasions based on network configuration and/or wireless device implementation. Based on the above estimate(s) of the channel, interference and/or noise, the wireless device computes and transmits one or more of the following parameters suitable for the transmission of a physical downlink channel in the CSI feedback/report to the network:
CSI-RS Resource Index/Indicator (CRI) or SSB Resource Index/Indicator (SSBRI): The wireless device may report one or more indices that indicate the channel measurement resource(s) (CSI-RS resource(s) and/or SSB(s)) with which one or more of the other parameters in the CSI feedback are associated. The network may configure one or more resources that the wireless device may measure. From the measurements of those resource(s), the wireless device may choose to associate one or more of those resources for a downlink physical channel transmission (e.g., PDSCH). Said resource(s) is/are indicated via CRI(s)/SSBRI(s).
Rank Index/Indicator (RI): This parameter denotes the rank of transmission (number of spatial layers of transmission). It is conditioned on a CRI or SSBRI. This means that the rank is computed from the measurements of the resource or is computed for a DL transmission associated with the resource denoted by the CRI/SSBRI.
Precoder Matrix Index/Indicator (PMI): The PMI provides information regarding the spatial precoding to be used (the mapping from the spatial layers for transmission for the PDSCH to a set of antenna port(s)) conditioned at least on a CRI/SSBRI and a corresponding RI. The spatial precoding information contained in the PMI may correspond to subband and/or wideband resolution in frequency, i.e., the information may pertain to the entire CSI reporting band and/or a subset of a CSI reporting band. The network may configure a codebook or precoding type for the computation of the precoding information. This is used in determining the format, size and parameters in the reported precoding information.
Channel Quality Index/Indicator (CQI): The wireless device reports one or more value(s) of CQI for the transmission of one or more transport blocks/codewords conditioned on a spatial precoder (i.e., the PMI or the precoder constructed using the PMI) and/or a RI. The CQI values typically denote modulation and coding schemes (MCS) that could be used for the transmission of a transport block/codeword. A CQI is determined based on the assumption/understanding that a transport block/codeword (of a PDSCH, for example) with the MCS denoted by the CQI would have a block error rate of at most 8, where ß is either a value known apriori to the wireless device or is provided by the network. In some examples, when there is no PMI computed by the wireless device, the CQI is conditioned on the RI, but not the PMI. In some other examples, the CQI may be computed conditioned directly on the reference signal measurements without any dependence or conditioning on a PMI or RI (for e.g., when there is no RI or PMI reported). The CQI can be wideband or subband based, i.e., the CQI can be reported for an entire CSI reporting band or for multiple subsets of bands in the CSI reporting band.
Layer Index/Indicator (LI): The LI indicates which column of the precoder matrix of the reported PMI corresponds to the strongest layer of the codeword corresponding to the largest reported wideband CQI.

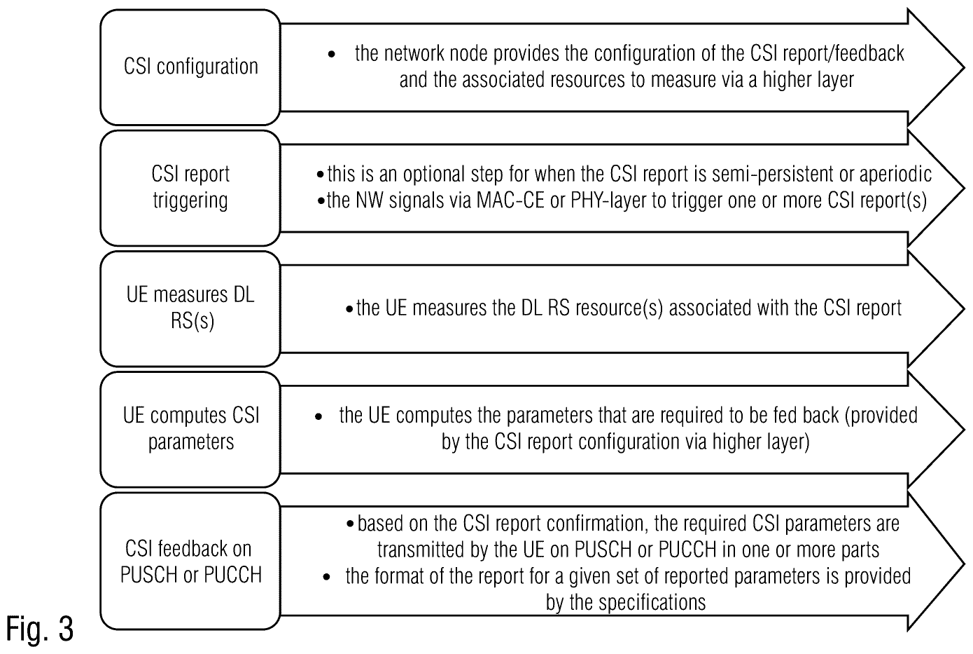

The CSI feedback/report provided by the wireless device comprising one or more of the above parameters is used for the scheduling of physical downlink channel(s) (e.g., the PDSCH or the PDCCH). FIG. 3 gives an overview on a typical CSI measurement and reporting timeline.

In general, the CSI report configuration provided to a wireless device by a network node comprises (indicates the wireless device to report) one or more of the parameters described above. The CSI report may be transmitted on the Physical Uplink Shared Channel (PUSCH) or the Physical Uplink Control Channel (PUCCH) in one or more parts. An illustration of the typical CSI measurement and reporting timeline in 3GPP 5G New Radio standards is provided in FIG. 3.

For the CSI configuration, the network node provides a configuration of the CSI report/feedback and the associated resources to measure via a higher layer. The CSI triggering report may be an optional step for when the CSI report is semi-persistent or aperiodic. The NW signals via MAC-CE or PHY-layer to trigger one or more CSI report(s).

In the next task the UE measures the DL RS resource(s) associated with the CSI report. Furthermore, the UE computes the parameters that are required to be feedback, e.g., provided by the CSI report configuration via higher layer. This means, that the UE may compute the CSI parameters.

The CSI feedback on PUSCH or PUCCH can be as follows: based on the CSI report confirmation, the required CSI parameters are transmitted by the UE on PUSCH or PUCCH in one or more parts. The format of the report for a given set of reported parameters is provided by the specification.

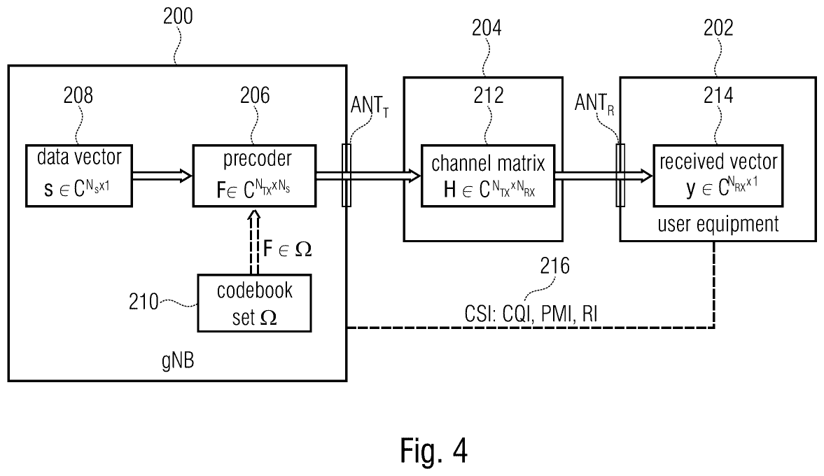

FIG. 4 shows a block-based model of a Multiple Input Multiple Output (MIMO) DL transmission using a codebook-based-precoding method. The base station 200, gNB, the user equipment, wireless device, 202 and the channel 204, like a radio channel for a wireless data communication between the base station 200 and the user equipment 202. The base station includes an antenna array ANTT having a plurality of antennas or antenna elements, and a precoder 206 receiving a data vector 208 and a precoder matrix F from a codebook 210. The channel 204 may be described by the channel tensor/matrix 212. The user equipment 202 receives the data vector 214 via an antenna or an antenna array ANTR having a plurality of antennas or antenna elements. A feedback channel 216 between the user equipment 202 and the base station 200 is provided for transmitting feedback information. The previous releases of 3GPP up to Release 15 support the use of several downlink reference symbols (such as CSI-RS) for CSI estimation at the wireless device.

In FDD systems (up to Rel. 15), the estimated channel at the wireless device is reported to the gNB implicitly where the CSI report transmitted by the wireless device over the feedback channel includes one or more of the following: the rank indicator (RI), the precoding matrix indicator (PMI) and the channel quality indicator (CQI) (and the CRI since Rel. 13), allowing the gNB to decide the spatial precoding, and the modulation order and coding scheme (MCS) of the symbols to be transmitted. The PMI and the RI are used to determine the spatial precoding from a predefined set of matrices Q also referred to as codebook. The codebook, e.g., in accordance with LTE, may be a look-up table with matrices in each entry of the table, and the PMI and RI from the wireless device decide from which row and column of the table the precoder matrix to be used is obtained. The precoders and codebooks are designed up to Rel. 15 for gNBs equipped with one-dimensional Uniform Linear Arrays (ULAs) having N₁ dual-polarized antennas (in total N_{TX}=2N₁ antennas), or with two-dimensional Uniform Planar Arrays (UPAs) having dual-polarized antennas at N₁N₂ positions (in total N_{TX}=2N₁N₂ antennas). It is assumed here that each antenna corresponds to an antenna port at the gNB. The ULA allows controlling the radio wave in the horizontal (azimuth) direction only, so that azimuth-only beamforming at the gNB is possible, whereas the UPA supports transmit beamforming on both vertical (elevation) and horizontal (azimuth) directions, which is also referred to as full-dimension (FD) MIMO. The codebook, e.g., in the case of massive antenna arrays such as FD-MIMO, may be a set of beamforming weights that forms spatially separated electromagnetic transmit/receive beams using the array response vectors of the array. The beamforming weights (also referred to as the array steering vectors) of the array are amplitude gains and phase adjustments that are applied to the signal fed to the antennas (or the signal received from the antennas) to transmit (or obtain) a radiation towards (or from) a particular direction. The components of the precoder matrix are obtained from the codebook, and the PMI and the RI are used to read the codebook and obtain the precoder. The array steering vectors may be described by the columns of a 2 Dimensional Discrete Fourier Transform (DFT) matrix when ULAs or UPAs are used for signal transmission.

The precoder matrices used in the Type-I, Type-I multi-panel and Type-II CSI reporting schemes in 3GPP New Radio Rel. 15 are defined in the frequency-domain and have a dual-stage structure (i.e., two components codebook): F(s)=F₁F₂(s), s=0 . . . ,S−1, where S denotes the number of subbands. The first component or the so-called first stage precoder, F₁ , is used to select a number of beam vectors from a Discrete Fourier Transform-based (DFT-based) matrix, which is also called the spatial codebook. Moreover, the first stage precoder, F₁ , corresponds to a wide-band matrix, independent of the subband index s, and contains L spatial beamforming vectors (the so-called spatial beams) bₗ∈ [symbol] ^{N}^{₁}^{N}^{₂}^{×1},l=0, . . . , L−1 selected from a DFT-based codebook matrix for the two polarizations of the antenna array,

$${F}_{1} = [ \begin{matrix}{b}_{0} & 0 \\ 0 & {b}_{0}\end{matrix} ] .$$

For the type_I codebook, L=1 such that F₁ is simply given by

$${F}_{1} = [ \begin{matrix}{b}_{0 , … ,} {b}_{L - 1} & \begin{matrix}0 & … & 0\end{matrix} \\ \begin{matrix}0 & … & 0\end{matrix} & {b}_{0 , … ,} {b}_{L - 1}\end{matrix} ] .$$

The spatial codebook comprises an oversampled DFT matrix of dimension N₁N₂×N₁O₁N₂O₂, where O₁ and O₂ denote the oversampling factors with respect to the first and second dimension of the codebook, respectively. The DFT vectors in the codebook are grouped into (q₁, q₂), 0≤q1≤O₁−1, 0≤q₂≤O₂−1 subgroups, where each subgroup contains N₁N₂ DFT-based vectors, and the parameters q₁ and q₂ are denoted as the rotation oversampling factors, with respect to the first and second dimension of the antenna array, respectively.

The second component or the so-called second stage precoder, F₂(s), is used to combine the selected beam vectors. This means the second stage precoder, F₂(s), corresponds to a selection/combining/co-phasing matrix to select/combine/co-phase the beams defined in F₁ for the s-th configured sub-band. For example, for a rank-1 transmission and Type-I CSI reporting, F₂(s) is given for a dual-polarized antenna array by

$${F}_{2} ( s ) = [ \begin{matrix}1 \\ {e}^{j {δ}_{1}}\end{matrix} ] ,$$

where e^{jδ}^{₁} is a quantized co-phasing factor (phase adjustment) between the two orthogonal polarizations of the antenna array. Hence, for the Type-I codebook, a single DFT-beam is selected per transmission layer of the precoding such that the transmission is directed for the strongest path component of the radio channel.

For a rank-1 transmission and Type-II CSI reporting, F₂(s) is given for dual-polarized antenna arrays by

$${F}_{2} ( s ) = [ \begin{matrix}{e}^{j {δ}_{0}} {p}_{0} \\ ⋮ \\ {e}^{j {δ}_{2 L - 1}} {p}_{2 L - 1}\end{matrix} ] ,$$

where pₗ and e^{jδ}^{₁}, l=0,2, . . . , 2L−1 are quantized amplitude and phase beam-combining coefficients, respectively. For rank-R transmission, F₂(s) contains R vectors, wherein R denotes the transmission rank, where the entries of each vector are chosen to combine single or multiple beams within each polarization.

The selection of the matrices F₁ and F₂(s) is performed by the wireless device based on reference signals such as CSI-RS and the knowledge of the channel conditions. The selected matrices are indicated in a CSI report in the form of a RI (the RI denotes the rank of the precoding matrices) and a PMI and are used at the gNB to update the multi-user precoder for the next transmission time interval.

In addition to the Type-I codebook, the Rel. 15 3GPP specification also defines a Type-I multi-panel (multi-antenna array) codebook for the case the gNB is equipped with multiple (co- located) antenna panels or antenna arrays that are possibly un-calibrated. The precoder for this codebook is similar to the Type-I codebook where a single DFT beam is applied per transmission layer of the precoding matrix. To take into account different spacing between the antenna panels and/or possible phase calibration errors (e.g., due to different local oscillators) between the antenna panels, a per-panel co-phasing factor is applied to each panel. For example, for a rank-1 transmission and a gNB that is equipped with Ng=2 antenna panels, the Type-I multi-panel CSI reporting is defined as

$$F ( s ) = [ \begin{matrix}{b}_{0} \\ {e}^{j {δ}_{1}} {b}_{0} \\ {e}^{j {δ}_{2}} {b}_{0} \\ {e}^{j {δ}_{1}} {e}^{j {δ}_{2}} {b}_{0}\end{matrix} ] ,$$

where e^{jδ}^{₁} and e^{jδ}^{₂} are quantized co-phasing factors with e^{jδ}^{₂} being a panel-specific co-phasing factor applied to the second panel.

### Beam Management

Considering the 5G NR system with the possibility of hybrid beamforming, the CSI needed for precoding may be obtained in two stages. The first is a beam management stage that establishes the desired shapes of the analog beams while the second is the CSI acquisition stage, as described above.

The beam management stage is considered as the procedure for selecting the beams at Tx and Rx. This can involve
one or more steps of transmission of DL RS(s) (such as SSB(s) and/or CSI-RS(s)) with or without repetition at each step, corresponding measurement of Layer1-Reference Signal Received Power (L1-RSRP) and/or Layer1-Signal to Interference plus Noise Ratio (L1-SINR) at the UEs and beam reporting from the UEs with preferred beam indices (e.g., through CRI or SSBRI) and the corresponding RSRP and/or SINR levels, followed by beam determination by the gNB, and/or
one or more steps of transmission of UL RS(s) (such as SRS(s)) with or without repetition at each step, corresponding measurements at the gNB, followed by beam determination by the gNB and possible beam reporting by the gNB to the UE with preferred beam indices (e.g., through SRI) and the corresponding RSRP and/or SINR levels so that the UE can determine its beam(s).

Either of the two methods of beam management mentioned above can involve the following tasks:
Beam sweeping: transmitting/receiving the RSs through multiples beam, each formed in a different direction, thereby enabling the UE or the gNB to cover a desired spatial area. This can involve utilizing different subsets of antenna elements (e.g., to save energy) as will be detailed in certain embodiments in the following.
Beam measurement: the gNB or UE measure characteristics of the different received beamformed signals.
Beam reporting: the UE (or gNB) reports beam information to the gNB (or UE) based on the measurements.
Beam determination: the gNB or the UE select their beam(s) to be used for DL/UL transmission or reception, or further beam refinement.

The determination of the DL Tx beam to perform one or more physical DL channel transmissions is performed via a beam sweeping procedure by the network node, e.g., the gNB. In a beam sweeping procedure, the gNB configures a set of DL RSs, like CSI-RS or SSB, via RRC for the UE to measure the set of DL RSs. Each of the configured DL RSs may be transmitted with a different spatial filter/beam, i.e., different direction, by the gNB. The UE measures each of the configured DL RS by receiving them using one or more spatial filters—the RSs may all be received with the same spatial filter or a different spatial filter may be used to receive each RS. Following the measurements, the UE sends a beam report to the gNB. The beam report comprises the indices of L configured DL RSs, essentially, L DL Tx beam directions, with each beam direction resulting from the use of a specific spatial filter at the gNB, along with one or more of the following parameters associated with each of the RSs:
Reference Signal Received Power (RSRP): Each reported RS is associated with an RSRP value or a differential RSRP value, wherein a differential RSRP value is calculated or reported with respect to the RSRP of one of the other reported RSs. The RSRP associated with an RS is computed/estimated/measured by a wireless device from the resource elements occupied by the RS.
Signal to interference-plus-noise ratio (SINR): Each reported RS is associated with an SINR value or a differential SINR value, wherein a differential SINR value is calculated or reported with respect to the SINR of one of the other reported RSs. The SINR associated with an RS is computed/estimated/measured at least from the REs associated with said RS, and the measurement(s) obtained from one or more interference measurement resources such as CSI-Interference management (CSI-IM) resource(s) and/or Non-Zero-Power CSI-RS resource(s) for interference.

The value of L can range from 1 to 4, in some examples. With the help of the beam reporting from the UE, the gNB determines one or more suitable DL Tx beam directions, i.e., one or more spatial filters for the transmission of the one or more PDCCHs and the PDSCH. The reported indices can be, depending on the DL RS(s) transmitted: CSI-RS Resource Index/Indicator (CRI) or SSB Resource Index/Indicator (SSBRI).

The ‘RSRP’ or ‘SINR’ reported by the wireless device may be referred to as ‘L1-RSRP/Layer1-RSRP’ or ‘L1-SINR/Layer1-SINR’ to denote a PHY-layer RSRP or SINR, respectively. Such an RSRP/SINR value is typically obtained from the REs associated with or occupied by the RS (in addition to measurements from one or more interference measurement resources for the SINR).

Typically, there is no filtering applied to said computed/estimated/measured RSRP/SINR value (i.e., L1-RSRP/SINR value) using, say, coefficients configured to the wireless device via a higher layer or a predetermined set of coefficients.

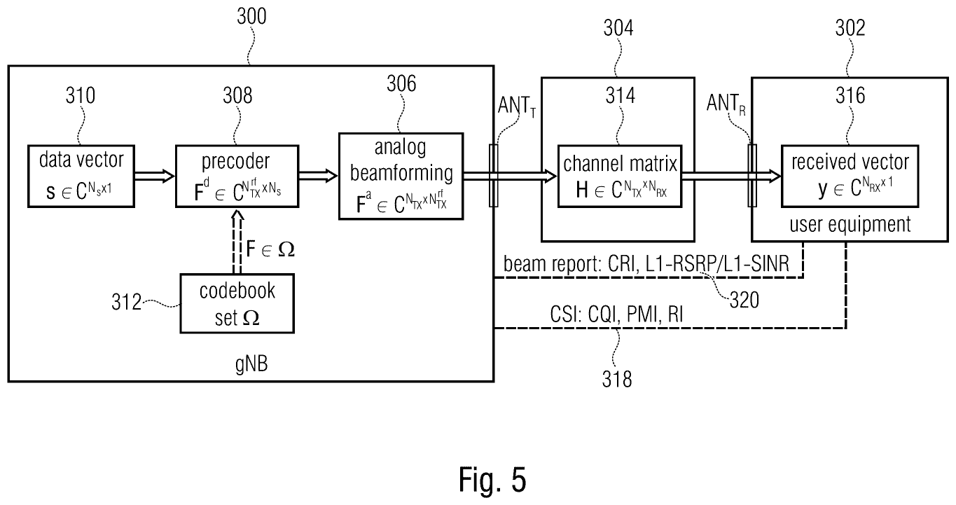

A schematic of a wireless system employing a MIMO DL hybrid beamforming model is provided in FIG. 5, where the codebook based precoding or digital beamforming stage is shown to follow by an analog beamforming stage that maps to the N_{TX} antenna elements at the gNB. Specifically, the precoder F^{d} mapping to

$${N}_{T X}^{r f}$$

vitural antenna ports corresponding to the number of RF chains is then followed by the mapping to the larger number of

$${N}_{T X} \geq {N}_{T X}^{r f}$$

through an analog beamforming matrix F^{a}. Note that expressing the overall beaforming as F(s)=F^{a}F^{d}(s)=F^{a}F₁F₂(s), s=0 . . . ,S−1, the special case of only precoding (explained above) is with

$${N}_{T X} = {N}_{T X}^{r f}$$

and F^{a} being an identity matrix. The beam reporting with L1-RSRP/SINR needed for beam management with hybrid/analog beamforming are also depicted in FIG. 5.

FIG. 5 shows also a block-based model of a MIMO DL transmission using codebook based coding method. The entity of FIG. 5 is substantial comparable to the entity of FIG. 4 but enhanced by the beam former 306. In detail, the base station 300 (comparable to the base station 200) is configured to communicate with a wireless device 302, comparable to the UE 202, using the channel 304 (comparable to the channel 204). The block 316 is comparable to the block 214, wherein the block 314 is comparable to the block 212. The base station 300 comprises a data vector 310 (cf. description of 208) a precoder 308, (cf. description of 206) and codebook 312 (cf. codebook 210). Additionally, the base station comprises an analog beam former 306 between the precoder 308 and the antenna ANTT.

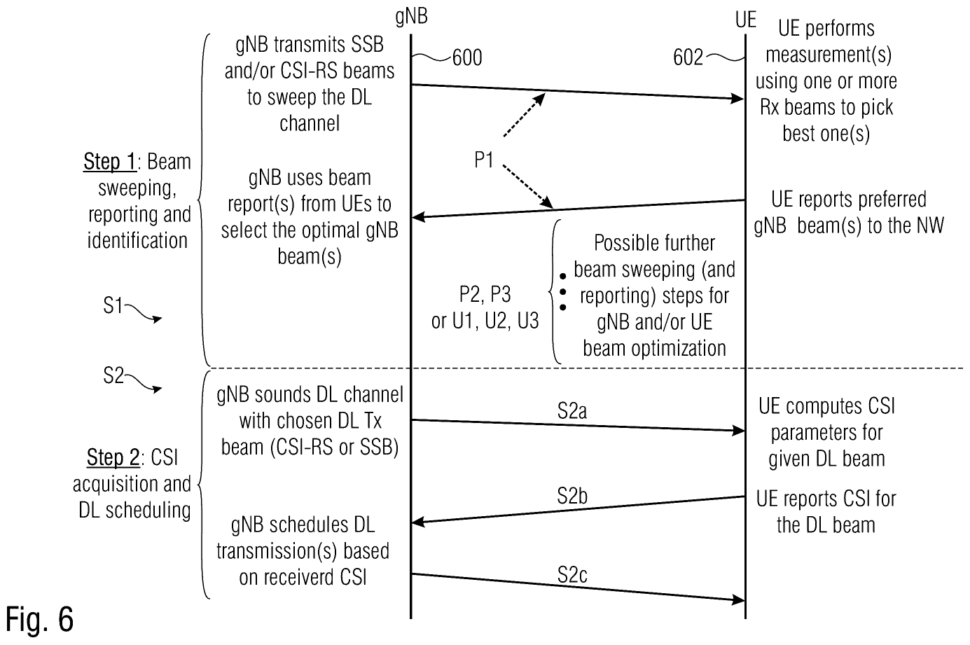

In FIG. 6 a time sequence chart for the two-stage process of link adaptation with hybrid/analog beamforming in the DL and/or UL is shown. For DL Tx/Rx beam management via DL RS transmissions, the following procedures are applicable as shown in FIG. 6:

FIG. 6 shows the communication between the gNB 600 and the UE 602. In the first step the beam sweeping, reporting and identification is done. This step is highlighted by the reference numeral P1. This procedure will be described below. According to embodiments, further procedures P2 and P3 may follow during the first step S1. During a second step S2, CSI acquisition and DL scheduling may be performed.

. Procedure P1: gNB transmits several DL RS resources by sweeping its Tx beam in different directions and UE performs measurements also by sweeping its Rx beam in different possible directions, based on which the UE can select its own desired Rx beam(s) and do reporting of one or more preferred gNB beam(s) to the gNB, with beam indices (indicated by CRI or SSBRI), so that the gNB can determine its selection of beam(s).
Procedure P2: possibility for further gNB Tx beam sweeping by fixing the selected UE beams(s) from P1 to perform UE measurement, based on which the UE can report again one or more gNB beams(s) to the gNB.
   This possibility can be utilized for optimizing/refining the gNB beam(s), e.g., for forming finer and more focused beams (for better link gain) or for changing the properties of the gNB beam(s) considering other metrics including network energy savings by employing reduced subsets of physical antenna elements from the available array, as will be detailed in certain embodiments in the following.
Procedure P3: possibility for enabling further UE measurement on DL RS transmissions by fixing the selected Tx beam(s) from P1 and P2, in order for the UE to further change/refine the UE beam(s).

The sub-steps belonging to the step S2 are as follows: the gNodeB 600 sounds DL channel with chosen DL Tx beam in the sub-step S2a so that the UE can compute CSI parameters for a given DL beam. As a response, the UE 602 reports CSI for the DL beam in sub-step S2b. The gNB 600 schedules DL transmission(s) based on received CSI (cf. step S2c).

When the beam pairing between a gNB and a UE, established through the above procedures involving DL RS transmissions for DL reception holds, for UL transmissions as well at the UE, the UE is understood to have ‘beam correspondence’. This correspondence between DL reception and UL transmission beams is a capability of a UE and is reported to a network node by the UE. When such beam correspondence does not hold at a UE, UL channel sounding with beamformed RSs is performed to determine the UL Tx beams at the UE and Rx beams at the gNB. Such UL sounding can be performed even with beam correspondence when it is found to be beneficial in certain circumstances (as we will propose in certain embodiments in the following). Replacing the optional procedures P2 and/or P3 above with procedures involving UL RS transmissions, like sounding reference signal (SRS) transmissions is helpful in reducing gNB power consumption and DL sounding overhead. The gNB performs measurements of SRS beams from the UE and triggers/schedules UL transmissions via SRS resource indicator (SRI) values. Similar to P2/P3, one or more steps of SRS beam sweeping, refinement and gNB Rx beam refinement/identification may be performed in this case. The uplink RS transmission (e.g, with SRS) based procedures can include, as indicated again in FIG. 6,
Procedure U1: UE transmits by sweeping UL Tx beam and the gNB performs measurements by sweeping its Rx beam, based on which the gNB can select its desired Rx beam(s) and trigger/schedule one or more preferred UE beam(s) using the UE beam/SRS indices (e.g., the SRS resource indicator, SRI).
Procedure U2: possibility for further gNB Rx beam sweeping by fixing the selected UE Tx beam(s) from U1 (or P1/P2) to perform gNB measurement of the SRS transmissions, based on which the gNB can optimize/change its own beam(s) for the UE, without requiring any feedback.
Procedure U3: possibility for further UE Tx beam sweeping by fixing the gNB Rx beam selected in U2, in order to refine/optimize the UE beam(s), with gNB measurements and beam reporting/triggering/scheduling from gNB to UE.

As will be detailed in the following, in certain embodiments, we propose advancements to the procedures P2 as well as U2 as options for optimizing gNB beams considering network energy savings in addition to other UE performance metrics. In essence, given the best the UE beam(s) selected from P1 or/and U1, in order to optimize gNB's beam(s), it can depend on a procedure involving
UE measurement of DL RS (typically CSI-RS/SSB) transmissions and enhanced UE beam reporting, or
UE transmission of UL RS (typically SRS) and gNB measurement and beam reporting. In either of the above cases, the desired gNB beam(s) can be determined for
maximizing energy efficiency while satisfying a given UE performance requirement (for e.g., user throughput, cell throughput, user reliability, etc.), or
maximizing UE performance while satisfying a given energy efficiency requirement.

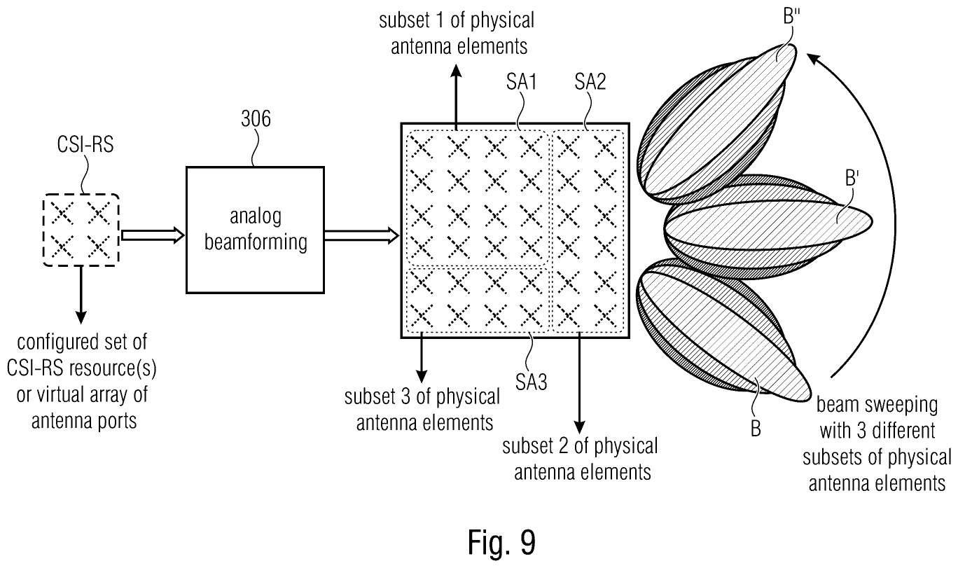

A depiction of the above explained possibilities for beam sweeping at the gNB with different subsets of physical antenna elements is shown in FIG. 9.

FIG. 9 shows that the CSI-RS resources (cf. CSI-RS are beamformed using the analog beam former 306). These CSI-RS resources are mapped by the beamformer to different subsets of physical antenna elements are used as illustrated by SA1, SA2 and SA3. Consequently, the gNB performs CSI-RS sounding with three beams—B, B′ and B″—associated with three different subsets SA1, SA2 and SA3 of physical antenna elements.

The term ‘higher layer’ in the following, typically denotes any communication layer above the physical (PHY) layer in the protocol stack such as the Radio Resource Control (RRC) layer, Medium Access Control (MAC) layer, etc. When it is used along with a reference to a layer ‘X’ in the protocol stack, for e.g., ‘Medium Access Control (MAC) layer or a higher layer,’ it denotes any layer above layer ‘X’ in the protocol stack (any layer above the MAC layer in the example above).

A reporting or transmission (or transmission of a report) by a wireless device via the physical (PHY) layer involves transmission of information (which may be a report) via a physical uplink channel such as the physical uplink control channel (PUCCH) or the physical uplink shared channel (PUSCH). A reporting or transmission (or transmission of a report) by a wireless device via a higher layer involves transmission of information via the medium access control (MAC) layer (e.g., using MAC-Control Element message(s)), the RRC layer, etc. The report or transmission is received by a network/network node/network entity.

A configuration or an indication by a network/network node provided/transmitted to a wireless device via the physical (PHY) layer involves transmission of information via a physical downlink channel such as the physical downlink control channel (PDCCH). The PDCCH carries downlink control information to the wireless device. A single transmission of a PDCCH may comprise a DCI of a predetermined or configured format. A configuration or an indication provided/transmitted by a network/network node/network entity to a wireless device via a higher layer involves transmission of information using one or more MAC-CE messages or RRC signalling to the wireless device.

In this disclosure, the terms ‘network’, ‘network node’ and/or ‘network entity’ can be used interchangeably, whenever/wherever applicable.

### Configuration and Acquisition of CSI With Respect to Subsets of CSI-RS Resources

In FR1 , as described above, the number of antenna ports being operated at a network node (e.g., base station/gNB) is directly proportional to the number of power amplifiers/analog beamforming networks/RF chains operated. Downlink transmissions of PDSCH and PDCCH are typically performed with CSI-RS resources as references, i.e., the DL transmissions are usually performed via the same antenna ports/panel(s)/element(s) as the ones used for the transmission of the reference CSI-RS resource. The number of ports of the reference CSI-RS resource is directly proportional to the number of the RF chains/power amplifiers/analog devices operated and hence the power consumption at the network node. Therefore, scaling down the number of ports used for a reference CSI-RS resource would considerably reduce the power consumption at the network node as all subsequent downlink transmissions using the CSI-RS resource as a reference would use a reduced number of ports/RF chains/analog devices at the network node. An important aspect of such a down-scaling would be to perform it in such a way that the required quality of service (QOS) for the wireless devices/user equipments served by the network is either guaranteed or is not impaired significantly. Thus, a ‘sustainable’ scaling down of the number of ports is required.

This can be achieved via slower maneuvers such as RRC reconfigurations of CSI-RS resource(s) and/or obtaining CSI feedback corresponding to CSI-RS resource(s) associated with different numbers/sets of ports at the network node over a period of time and/or several CSI feedback or reporting occasions. These methods involve high latency (which may lead to slower adaptation compared to rapidly changing network conditions in certain scenarios) and/or high control information overhead by design. A dynamic and low-latency adaptation of spatial elements at the network is therefore required via UE-network signalling and/or co-operation while catering to various deployment use-cases, power-saving requirements and network and UE capabilities.

One of the methods to switch between different subsets of arrays or fall back to a smaller subset of the antenna array at a base station, is for the network to request CSI feedback with regard to a specific subset or one or more subsets of ports associated with the DL resource used for measurement(s) to compute the CSI feedback.

In certain embodiments, a method for wireless communications performed by a wireless device (user equipment) is proposed, the method comprising,
receiving from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the wireless device,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the report configuration,
performing measurements at least on said at least one CSI-RS resource provided by the CSI report configuration,
computing one or more parameters related to a channel state information, CSI, and/or DL transmission rate and/or reliability associated with at least one of the P subsets of a CSI-RS resource configured or indicated by the network node, and
transmitting a report to the network node via the PHY-layer or a higher layer, the report comprising at least one or more of said computed parameter(s) associated with at least one of the P subsets of a CSI-RS resource configured or indicated by the network node.

In certain embodiments, the spatial domain resource(s) associated with a CSI-RS resource, is/are the port(s) associated with the CSI-RS resource.

In certain embodiments, the frequency domain resource(s) associated with a CSI-RS resource, is/are the physical resource block(s) associated with the CSI-RS resource.

In certain embodiments, the time domain resource(s) associated with a CSI-RS resource, is/are the symbols(s) associated with the CSI-RS resource in a slot/subframe/frame.

In certain embodiments, a parameter related to a CSI is one or more of the following: a channel quality indicator (CQI), a modulation and coding scheme (MCS), a rank, a precoding information (e.g., a precoding matrix indicator of a certain type defined in the 3GPP specification), a reference signal received power (RSRP), a signal-to-interference-plus-noise ratio (SINR).

In certain embodiments, a parameter related to a DL transmission rate is one or more of the following: a spectral efficiency (which may be indicated in some examples by a MCS, CQI and/or rank), a throughput, a transport block size, a code rate, a modulation order, a rank.

In certain embodiments, a parameter related to a DL transmission rate and/or reliability is a block error rate (BLER) (e.g., a BLER corresponding to one or more transport blocks or one or more codeblocks) and/or a BLER target.

In some examples, the value of a parameter may be expressed as a differential value with respect to the same for another resource or subset.

In certain embodiments, said CSI report configuration provides at least one of the following:
one or more non-zero power (NZP) CSI-RS resources for channel measurement,
one or more zero power (ZP) CSI-RS resources for interference measurement,
one or more CSI-Interference management (CSI-IM) resources for interference measurement,
one or more NZP CSI-RS resources for interference measurement.

In some examples, said CSI report configuration provides at least one or more NZP CSI-RS resources for channel measurement. In some other examples, said CSI report configuration provides at least one or more NZP CSI-RS resources for channel measurement and one or more CSI-IM resources or ZP CSI-RS resources for interference measurement.

In certain embodiments, said CSI report configuration comprises a configuration or indication of P≥1 subset(s) of time, frequency and/or spatial domain resource(s) and/or parameter(s) related to them, associated with at least one of the CSI-RS resource(s) provided by said report configuration.

In certain embodiments, a configuration or indication of P>1 subset(s) of time, frequency and/or spatial domain resource(s) and/or parameter(s) related to them, associated with at least one CSI-RS resource is provided by the network node to the wireless device via a MAC-CE message.

In certain embodiments, the network provides to the wireless device, via the PHY-layer and/or a higher layer, a configuration or indication of one or more parameter(s) related to a channel state information, CSI, and/or DL transmission rate and/or reliability associated with at least one of the subsets of a CSI-RS resource, that the wireless device shall measure, compute and/or report. In some examples, the indication may be provided by a PDCCH comprising a DCI of a format used for downlink or uplink scheduling (e.g., DCI format 0_0, 0_1, 0_2, 1_0, 1_1 or 1_2). A pattern of a bit field in a DCI may map to/indicate a certain predetermined (or higher-layer configured) set of one or more said parameters.

In certain embodiments, said CSI report configuration provides one or more parameter(s) to be measured, computed and/or reported for one or more of said P≥1 subset(s) of time, frequency and/or spatial domain resource(s) associated with a CSI-RS resource, wherein the parameters can be related to a channel state information, CSI, and/or DL transmission rate and/or reliability.

In certain embodiments, an indication of the one or more parameter(s) to be measured, computed and/or reported for one or more of said P>1 subset(s) of time, frequency and/or spatial domain resource(s) associated with a CSI-RS resource, is provided by the network node to the wireless device via a MAC-CE message.

In certain embodiments, the reporting is performed using a CSI report, wherein the CSI report is transmitted by the wireless device on the physical uplink shared channel (PUSCH) or the physical uplink control channel (PUCCH).

In certain embodiments, the wireless device is configured to perform said reporting in response to/in association with a CSI report configuration. The reporting is performed via the PHY-layer and is transmitted on the PUSCH or the PUCCH.

In certain embodiments, the wireless device is configured to perform said reporting via a MAC-CE message or via the RRC layer.

The above method gives rise to different possibilities of wireless device reporting and network configuration of the subsets, each with its own consequence for the specifications and network/wireless device implementation.

### Network Signalling of Information Regarding the Subsets

The network is best equipped to configure subsets of a CSI-RS resource, wherein the subsets may be in spatial/time/frequency domain. From a network implementation perspective, a subset of a CSI-RS resource would correspond to a subset of antenna ports/RF chains/analog devices that the network would like to scale down to, from the CSI-RS resource's current/original set of antenna ports/RF chains/analog devices. In a typical network implementation, using rectangular or linear subsets of antenna elements from an antenna array at the network node and the corresponding analog/RF chain network(s) behind it would be helpful for reusing the DFT/Walsh-Hadamard based precoding used in various standards (e.g., 5G NR, LTE, etc.). The network may thus configure/indicate ‘valid’ subsets within a CSI-RS resource, i.e., the set of spatial/time/frequency domain resources within the CSI-RS that make up a sub-array that a network would like to operate.

In certain embodiments, the wireless device is configured to receive a higher layer configuration or an indication via a MAC-CE message or PHY-layer, P≥1 subset(s) of ports associated with at least one CSI-RS resource.

In certain embodiments, the wireless device is configured to receive a higher layer configuration or an indication via a MAC-CE message or PHY-layer, P≥1 subset(s) of time and/or frequency resources associated with at least one CSI-RS resource.

The configuration of port-based, i.e., spatial-domain-based, subsets for a CSI-RS resource would be helpful in directly configuring subarrays whose pilots are spread in the same bandwidth and/or symbols as the CSI-RS resource. The configuration of time/frequency domain based subsets may help in the reduction in the number of ports from the CSI-RS resource, reduction in the bandwidth from the CSI-RS resource, or a reduction in the repetition(s) or time-domain bundling for the subsets. For example, the ports of a CSI-RS resource may be spread across distinct symbols that a selection of a subset of the symbols of the CSI-RS resource would lead to a selection of a subset of ports of the CSI-RS resource. In some other examples, the selection of a subset of PRBs associated with a CSI-RS resource would mean a reduction in the CSI-RS bandwidth. Selection/configuring of such subsets may help in operating bandwidth reduction in the DL, which may have some power saving effects as well.

In certain embodiments, each configured or indicated subset associated with a CSI-RS resource is provided with or associated with an identifier/index/indicator

In certain embodiments, the wireless device is configured to receive a higher layer configuration or an indication via a MAC-CE message or PHY-layer, of a subset associated with a CSI-RS resource wherein the configuration/indication comprises at least one bitmap whose length is equal to one of the following:
the number of ports configured for said CSI-RS resource,
the number of physical resource blocks associated with said CSI-RS resource,
the number of symbols associated with said CSI-RS resource.

The ports/PRBs/symbols selected via said bitmap may configure/indicate a subset of a CSI-RS resource.

In certain embodiments, the UE is configured to receive from a network node via the PHY-layer and/or a higher layer, a configuration or indication of one or more parameters related to at least one subset associated with a CSI-RS resource. In some examples, the parameter(s) may be at least one of the following:
A ‘muting’ pattern for a subset associated with said CSI-RS resource, wherein the pattern indicates or configures one or more of the following: a set of ports, a code/time/frequency division multiplexing pattern.
A codebook/array/panel configuration associated with said subset.
One or more parameter(s) associated with the computation of a precoder associated with said subset (e.g., subband configuration, size of one or more basis sets used for precoder computation, etc.).

With the subsets configured/indicated to the UE by the network node, the UE may also be provided with parameters related to the subset for the computation or reporting of a CSI related to the subset.

In certain embodiments, the wireless device is configured to receive a higher layer configuration or an indication via a MAC-CE message or PHY-layer, a codebook/precoding configuration or at least one or more parameters associated with a codebook/precoding configuration for the measurement, computation and/or reporting of one or more parameters related to a CSI and/or DL transmission rate or reliability associated with at least one of the said subsets of a CSI-RS resource. In some examples, the parameters associated with a codebook configuration may be at least one of the following:
codebook type (for e.g., 3GPP codebooks such as type-I, type-Il, enhanced type-Il, multi-panel type-I, port-selection, etc.), dimensions to be used for the computation/selection/evaluation of a codebook or a precoding information (for e.g., variable N1/N2 that are used to indicate the dimension of a DFT/Walsh-Hadamard precoding vector/matrix),
size/dimension of a CSI parameter (for e.g., a quantized value/coefficient in a CSI, a bitmap, a number of coefficients for a channel/precoder parameter, etc.) involved in the computation of a precoding information,
a number of subbands or a size of a subband for the computation of a precoding information.

Types of subsets configured for a CSI-RS resource

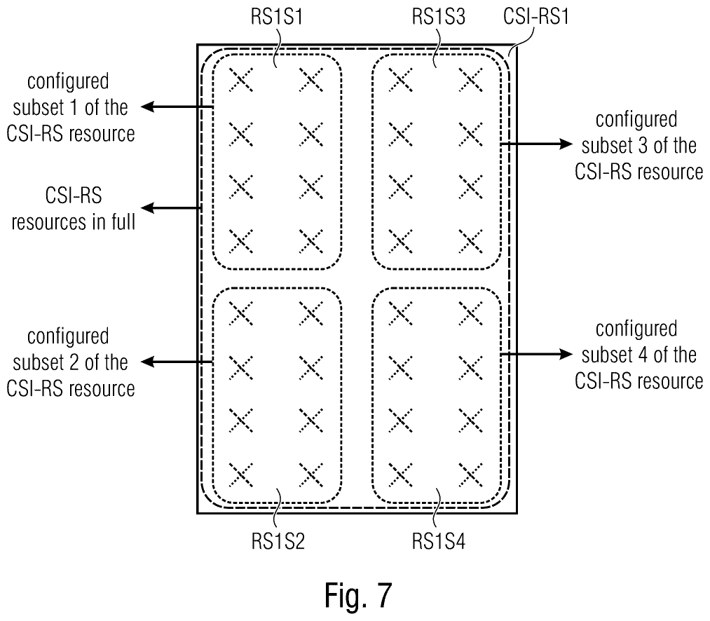

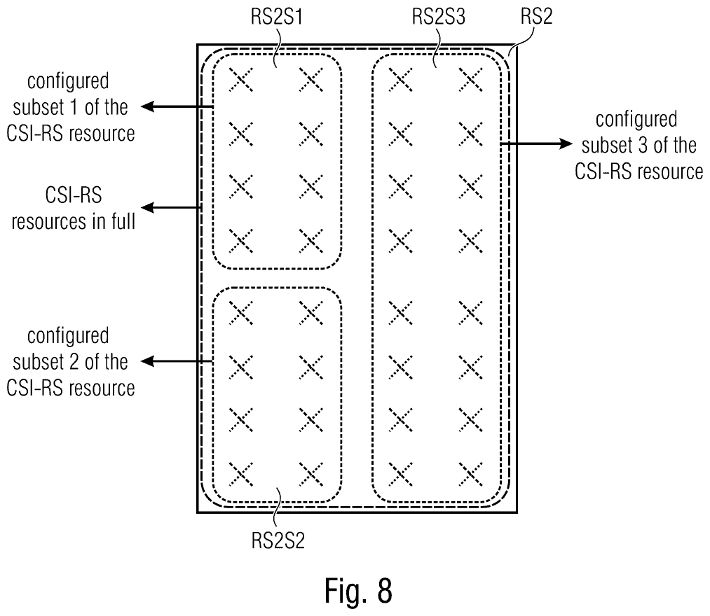

In the above method, a CSI-RS resource may correspond to the antenna ports associated with the whole antenna array while the subsets may be associated with distinct (overlapping or non-overlapping) subarrays of said antenna array. Two examples of CSI-RS resource and subsets configuration (with non-overlapping subarrays) for a base-station antenna array are shown in FIG. 7 and FIG. 8.

FIG. 7 shows a first example for CSI-RS resources (cf. CSI-RS1). Here four subsets RS1-S1, RS1-S2, RS1-S3 and RS1-S2. This means, that the ports of the CSI-RS1 resource are subdivided across four subarrays.

FIG. 8 shows a configuration, where the ports of the CSI-RS2 resource are subdivided into three subarrays RS2-S1, RS2-S2 and RS2-S3.

In certain embodiments, the wireless device is configured to receive a higher layer configuration or an indication via a MAC-CE message or PHY-layer, P≥1 subset(s) associated with at least one CSI-RS resource, wherein all the subsets comprise an identical number of ports, and the number of ports associated with a subset is less than that configured for the associated CSI-RS resource.

In certain embodiments, the wireless device is configured to receive a higher layer configuration or an indication via a MAC-CE message or PHY-layer, P≥1 subset(s) associated with at least one CSI-RS resource, wherein at least one subset is associated with a different number and/or set of ports from that of at least one other subset, and the number of ports associated with a subset is less than that configured for the associated CSI-RS resource.

Similarly, when the subsets are configured with respect to subsets of time/frequency domain resources, the following types of subsets may be possible.

In certain embodiments, the wireless device is configured to receive a higher layer configuration or an indication via a MAC-CE message or PHY-layer, P≥1 subset(s) associated with at least one CSI-RS resource, wherein all the subsets comprise an identical number of physical resource blocks and/or symbols, and the number of physical resource blocks and/or symbols associated with a subset is less than that configured for the associated CSI-RS resource.

In certain embodiments, the wireless device is configured to receive a higher layer configuration or an indication via a MAC-CE message or PHY-layer, P≥1 subset(s) associated with at least one CSI-RS resource, wherein at least one subset is associated with a different number or set of physical resource blocks and/or symbols from that of at least one other subset, and the number of physical resource blocks and/or symbols associated with a subset is less than that/those configured for the associated CSI-RS resource.

### UE Feedback with Respect to Different Subsets

If the network acquires feedback with respect to multiple subsets in the CSI-RS resource, the decision on which subarray to use for DL transmissions may rest on the network. There may be different possibilities for the wireless device's reporting of CSI with respect to multiple subsets. In one possibility, the network may collect a detailed CSI report with respect to each subset, wherein one or more CSI parameters are acquired.

In certain embodiments, the wireless device is configured to measure, compute and/or report to a network node via the PHY-layer or a higher layer, one or more parameters related to a

CSI and/or DL transmission rate and/or reliability associated with K subsets associated with a CSI-RS resource, wherein 1≤K≤P.

In certain embodiments, the UE is configured to measure, compute and/or report to a network node, at least one of the following parameters associated with one or more of the K subsets associated with a CSI-RS resource:
wideband or subband CQI value(s)
precoding matrix indicator(s) or information related to precoding matrix indicator(s)
rank indicator
layer indicator

In certain embodiments, the value of K is
configured by the network,
equal to P and/or
fixed in the specifications.

The set of parameter(s) to measure, compute and/or report and the setting(s) related to the same (wideband/subband, precoding type, codebook-related details, etc.) may be configured to the wireless device by the network node (for e.g., in the CSI report configuration).

In certain embodiments, the value of K is determined by the wireless device. In some examples, the maximum value of K that the wireless device can use is indicated by the network, fixed in the specification and/or equal to P.

In certain embodiments, the report provided by the wireless device may comprise at least the following:
The identifiers of K subsets associated with at least one CSI-RS resource, where 1≤K≤P.
For each subset, one or more of the following parameters:
   wideband or subband CQI value(s),
   precoding matrix indicator(s) or information related to precoding matrix indicator(s),
   rank indicator,
   layer indicator

Giving a detailed CSI report with respect to each subset obviously results in very high uplink control information (UCI) overhead. Moreover, if the network ends up choosing only one of the subsets for DL transmissions, the detailed feedback with respect to the other subsets are useless information. Therefore, a second method involving a two-step procedure is proposed:
The wireless device first reports a ‘representative information’ with respect each of the K subsets.
Based on the representative information reported by the UE, the network requests detailed CSI with respect to one of the K subsets.

The ‘representative information’ in the above method may be a performance metric or a measurement made with respect to each subset. Following this report, the network may determine which subset offers an expected performance and/or power-saving trade-off and/or satisfies scheduling and/or traffic conditions. This is then followed by a request for detailed CSI with respect to said subset by the network from the wireless device.

In certain embodiments, the wireless device is configured to measure, compute and/or report to a network node via the PHY-layer or a higher layer, at least one of the following parameter(s) associated with one or more of the K subsets associated with a CSI-RS resource, wherein 1≤K≤P:
a performance/measurement metric,
a differential or a relative performance/measurement metric with respect to the same metric computed in association with said CSI-RS resource,
a differential or a relative performance/measurement metric with respect to the same metric computed in association with one of the P subsets associated with said CSI-RS resource.

The value of K is configured by the network, is equal to P or is fixed in the specifications. In some examples, the value of K is determined by the wireless device. The performance/measurement metric(s) mentioned above may provide information related to a CSI and/or DL transmission rate and/or reliability associated with a physical DL channel.

In certain embodiments, the performance/measurement metric(s) and/or the differential/relative performance/measurement metric(s) measured, computed and/or reported to a network node via the PHY-layer or a higher layer by a wireless device, with respect to one or more subsets associated with a CSI-RS resource, is/are at least one of the following:
a reference signal received power (RSRP) or a differential RSRP,
a signal to interference-plus-noise ratio (SINR) or a differential SINR,
an index/indicator of a modulation and coding scheme (MCS) or a differential MCS index/indicator,
a channel quality indicator/index, CQI, or a differential CQI,
a value/differential value (or an indicator of a value/differential value) of a throughput/spectral efficiency or any other parameter related to a data rate or reliability,
a rank or a differential rank value/indicator,
a BLER or a differential BLER value/indicator

In certain embodiments, the same set of one or more parameters is reported for each of the K subsets reported by the wireless device.

By reporting of one of the above parameters related to a subset (measured or achieved RSRP/SINR/data rate/BLER with the subset either in absolute values or in comparison with a ‘reference’ CSI-RS resource or ‘reference’ subset of a CSI-RS resource), the network may be able to decide if a certain subset is suitable for the current scheduling and/or traffic conditions and/or satisfying the QoS requirement(s) of one or more UEs attached to the network or not.

In some examples, a (differential) RSRP or an SINR value reported for a CSI-RS resource subset would be enough to gauge the strength/possible Rx threshold of the link for a CSI-RS resource subset. This might however not be enough to determine the QoS offered by a CSI-RS resource subset. Similarly, a (differential) BLER value of a subset could be used to measure a subset's reliability and a rank could be used to measure a subset's spatial multiplexing capability. If only a (differential) CQI/MCS value is reported for a subset, the information provided by it would be incomplete as only when its combined with a rank and/or precoder does the base station have some sense of the data rate/throughput/BLER attainable. Therefore, a combination of some of the parameters would convey useful information to the network to make scheduling decisions.

In certain embodiments, the wireless device is configured to measure, compute and/or report via the PHY-layer of a higher layer, at least two of the following parameters for one or more subsets associated with a CSI-RS resource:
an index/indicator of a modulation and coding scheme (MCS) or a differential MCS index/indicator,
a channel quality indicator/index, CQI, or a differential CQI,
a rank or a differential rank value/indicator,
a BLER or a differential BLER value/indicator

In scenarios where the UE reports relative or differential performance metric associated with a subset of a CSI-RS resource, it is with respect to the same performance metric computed for the associated CSI-RS resource, which may additionally be reported as well. In some examples, the UE reports relative or differential performance metric associated with a subset of a CSI-RS resource with respect to the same performance metric computed for another subset of said CSI-RS resource.

In certain embodiments, the wireless device is configured to measure, compute and/or report to a network node via the PHY-layer or a higher layer, one or more parameters related to a CSI and/or DL transmission rate and/or reliability associated with K subsets associated with a CSI-RS resource, along with one or more parameters related to a CSI and/or DL transmission rate and/or reliability associated with the CSI-RS resource. In some examples, the value(s) of one or more parameter(s) associated with the K subsets of the CSI-RS resource are reported relative to (or as a differential with respect to) the value(s) of the same parameter(s) associated with the CSI-RS resource.

In certain embodiments, the report provided by the wireless device may comprise at least the following:
The identifiers of K subsets associated with at least one CSI-RS resource, where 1≤K≤P.
For each subset, one or more parameters related to a CSI and/or DL transmission rate and/or reliability associated with a physical downlink channel.

In certain embodiments, the report provided by the wireless device may also comprise one or more parameters related to a CSI and/or DL transmission rate and/or reliability associated with a CSI-RS resource along with the information regarding K subsets associated with said CSI-RS resource.

In one example, the report comprises a CSI-RS resource indicator (CRI) indicating said CSI-RS resource and one or more parameters related to a CSI and/or DL transmission rate and/or reliability associated with said CSI-RS resource/CRI. In some other examples, the report does not comprise a CRI, but it comprises one or more parameters related to a CSI and/or DL transmission rate and/or reliability associated with said CSI-RS resource. In such cases, the CSI report configuration associated with said report from the wireless device comprises just one CSI-RS resource for channel measurement.

In a variation of the above method or reporting, the reported subsets may be ordered based on decreasing or an increasing value of a performance or measurement metric associated with the subsets.

In certain embodiments, the K subset(s) provided by the wireless devices in the report are ordered based on an increasing or decreasing order of a certain performance or measurement metric. In some examples, the K subsets are ordered based on at least one of the following:
Increasing/decreasing loss in throughput/data rate/spectral efficiency,
Increasing/decreasing gain in BLER.
Increasing/decreasing value of CQI/MCS and/or rank.

In certain embodiments, the wireless device is configured to measure, compute and/or report to a network node via the PHY-layer or a higher layer, a differential or a relative performance/measurement metric associated with a subset associated with a CSI-RS resource, with respect to the same metric computed in association with one of the other K subsets provided in the report.

In certain embodiments, the wireless device is configured to measure, compute and/or report to a network node via the PHY-layer or a higher layer, a differential or a relative performance/measurement metric associated with a subset associated with a CSI-RS resource, with respect to the same metric computed in association with the subset provided before/after it in the report.

The above methods do not restrict the reporting with respect to different groups of subsets/subarrays, i.e., a set of subsets of the CSI-RS resource can be reported based on a certain decision making by the UE with information on certain subarrays totally omitted. Including restriction of the types of subarrays reported would be helpful for the gNB to get information on the best subarrays within a given group of subarrays. For example, the gNB may configure a total of 4 subsets for a CSI-RS resource with 32 ports wherein 2 subsets with 8 ports each and 2 subsets with 16 ports each are present. If the UE reports only on the subsets with 8 ports or 16 ports, the gNB may know nothing of the performance of the other subset.

In certain embodiments, M>1 groups of said P subsets of a CSI-RS resource are present, wherein the wireless device shall provide to a network node in a report, one or more parameters related to a CSI and/or DL transmission rate and/or reliability associated with K (1≤K≤P) subsets of a CSI-RS resource, wherein among the K subset(s), when K≥2
at least two of the subsets belong to two different groups, or
every subset belongs to a different group.

In certain embodiments, the M groups are configured by a network node or determined via predetermined/fixed parameter(s) related to the subset(s).

In certain embodiments, the UE reports one or more said parameters with respect to a subset ‘S’ within a group of subsets comprising two or more subsets, wherein said subset ‘S’ performs the ‘best’ compared to the other subsets in said group with respect to one or more parameters related to a CSI and/or DL transmission rate and/or reliability. In some examples, the parameter(s) with respect to which the comparison of the performance is performed is/are at least one of the following: BLER, CQI, MCS, rank, throughput, spectral efficiency, RSRP and/or SINR.

In certain embodiments, the wireless device is configured to receive an indication of a transmission configuration indication, TCI, state that comprises one or more DL/UL reference signals and one or more quasi-colocation, QCL, types associated with them, for the reception, measurement and/or computation(s) related to at least one subset associated with a CSI-RS resource.

A QCL-type is an indication of the set of parameter(s) to be derived and/or applied for the reception and/or transmission of a channel or reference signal, with reference to a DL/UL reference signal. An RS or a physical downlink/uplink channel may be provided with a transmission configuration indication, TCI, state that comprises one or more RSs that are associated with one or more QCL types. For example, a CSI-RS resource ‘A’ and an associated QCL type ‘X’ may indicate that the wireless device shall use a Doppler shift/spread and/or delay spread value obtained from CSI-RS ‘A’ for the reception or transmission of a channel or RS. In another example, a SSB ‘B’ and an associated QCL type ‘Y’ may indicate that the wireless device shall use a Rx spatial filter used for the reception of SSB ‘B’ to determine the spatial filter for the reception or transmission of a channel or RS. One or more QCL types or settings for UL/DL channels and/or RSs may be provided by a TCI state.

In one example, the subsets with identical number of time, frequency and/or spatial resources are included in the same group.

In another example, the subsets with the same TCI states are included in the same group.

### UE Selection of Subset for Reporting

If the above reporting of the parameters is performed with respect to multiple subsets, the network may ultimately determine the suitable subset of the CSI-RS resource to use as a reference for upcoming DL transmissions. However, if the UE does not report with respect to all the configured subsets for the CSI-RS resource, then the UE has some part in the decision made as well. In the case that the wireless device chooses and reports exactly one subset, it means that the decision on which subset to use falls squarely to the UE, which may optimize its reporting according to a predetermined or indicated performance/measurement metric. With the UE possessing the best knowledge of the receiving conditions and its own processing capabilities, leaving the decision to the wireless device would save both uplink control information and downlink sounding overhead.

In certain embodiments, the wireless device measures, computes and/or reports to the network node via the PHY-layer or a higher layer, one or more parameters related to a channel state information, CSI, and/or DL transmission rate and/or reliability associated with one of the P subsets configured or indicated by the network node for a CSI-RS resource.

As shown in the examples in FIG. 6 and FIG. 7, the subsets may be identical or non-identical in size (the number of ports or time/frequency domain resources associated with them). If the wireless device is reporting a CSI with respect to one or more of the subsets, the ones chosen for reporting by the wireless device may be based on one or more CSI or DL performance metrics as described above. In cases where the sizes of the subsets are non-identical, the metrics used for reporting of the subsets may always be skewed in favour of the subset assigned with the larger number of time/frequency/spatial resources. For example, a subset with a larger number of ports may always end up providing a RSRP, rank and/or throughput than a subset with a fewer number of ports. Similarly, using a CSI-RS resource whose bandwidth is a subset of another would always put the resource with the smaller bandwidth at a disadvantage in terms of throughput. In the following, methods for a fair assessment across asymmetric subsets by a wireless device are discussed.

In certain embodiments, the wireless device is configured to receive from a network node, one or more parameters via the PHY-layer or a higher layer that is/are used for at least one of the following:
To choose to report a subset pi among the P subset(s) of a CSI-RS resource along with one or more parameter(s),
the computation of one or more parameter(s) related to a CSI and/or DL transmission and/or DL transmission rate and/or reliability associated with subset pi-In certain embodiments, the wireless device is configured to receive from a network node at least one value of a threshold for a parameter related to a CSI, DL transmission rate and/or reliability, via the PHY-layer or a higher layer. If a value of said parameter for a certain subset pi is greater than said at least one value of threshold, then the UE may, depending on other conditions, if any, choose to report subset pi to the network node.

For example, the UE may be provided with a threshold for at least one of the following parameters: RSRP, SINR, throughput, BLER, spectral efficiency, CQI/MCS. The threshold may also be indicated in the differential sense. If the parameter computed with respect to a subset pᵢ “crosses” said threshold, then the UE may choose to report it over at least one other subset pⱼ among the P subsets configured for a CSI-RS resource. Depending on the parameter for which the threshold is defined, the UE may check if the parameter should be greater than or less than a threshold for a subset to be reported.

Consider a second example where there are M>1 groups of subsets among the P subsets configured for a CSI-RS resource, wherein the i-th group comprises nᵢ≥1 subsets. All the subsets of a given group comprise the identical number of time, frequency and/or spatial domain resources. For instance, each subset within a group may be associated with distinct subarray at the base station, wherein all the subarrays corresponding to the group are of equal size. Or, each subset may be associated with different sets of PRBs associated with the CSI-RS resource, but identical number of PRBs across all the subsets within a group. Any two subsets from two different groups have non-identical number of time, frequency and/or spatial domain resources. The UE shall be provided with at least one threshold value t, for a specific parameter that the UE computes with respect to a CSI-RS resource subset. Let the value computed for said parameter with respect to the j-th subset in group i, denoted as

$${p}_{j}^{( i )} , be {v}_{j}^{( i )} .$$

Without loss of generality, let the groups (indicated by i) of subsets be ordered in increasing order of number of time, frequency and/or spatial domain resources. If

$$t \leq {v}_{j}^{( {i}_{c} )} > {v}_{j ′}^{( {i}_{c} + k )} ( or t \geq {v}_{j}^{( {i}_{c} )} < {v}_{j ′}^{( {i}_{c} + k )} )$$

for any k>0 and any value of j or j′, then the UE shall choose to report one of the subsets from group i_{c}. And, if there are multiple values of i_{c} that satisfy the above inequality, the UE shall choose to report one of the subsets from the group corresponding to the least value of i_{c}. Both type of inequalities can be considered for comparison as the performance/measurement metrics can be ‘positive’ or ‘negative’ metrics. For example, throughput, CQI, rank, RSRP, SINR etc. are categorized as ‘positive’ metrics as higher the value of the metric for a subset, the better the performance. On the other hand, BLER is considered a ‘negative’ metric as lower the value of the metric for a subset, the better the performance.

This way, the UE chooses to report a subset with the least amount of resources that crosses the threshold, thereby aiding network energy savings with very little uplink control information overhead. The threshold can be a way for the network to ensure reliability or a certain throughput/QoS for the UE.

In certain embodiments, the wireless device, for the measurement, computation and/or reporting of at least one parameter related to a CSI, DL transmission rate and/or reliability associated with a subset of a CSI-RS resource,
receives from the network node via the PHY-layer or a higher layer, at least one value of a threshold t, or
knows apriori (for e.g., predetermined/fixed in the specifications or known via UE implementation) at least one value of a threshold t.

In certain embodiments, the wireless device reports to a network node via the PHY-layer of a higher layer, at least an index/indicator/identifier of a subset associated with said CSI-RS resource, wherein the value of said at least one parameter associated with said subset is greater than (or less than) a threshold t.

In one example, if the parameter is a BLER, the value of said parameter associated with said subset is less than the threshold t. In another example, if the parameter is a CQI/spectral efficiency/rank/data rate/throughput among others, the value of said parameter associated with said subset is greater than the threshold t.

With the above threshold set, a comparison with the threshold for the reported subset along with the comparison with other subsets (in terms of the number of resources or an implementation based determination of subset size, for e.g., based on subset index) determines the reported subset at the UE.

In certain embodiments, the wireless device is configured to report to a network node, at least an index/indicator/identifier of a first subset associated with said CSI-RS resource, wherein at least one of the following conditions apply:
the value of said at least one parameter associated with said first subset is greater than (or less than) a predetermined, preconfigured or configured threshold t, the value of said at least one parameter associated with at least one other subset among
the P subsets associated with the CSI-RS resource is greater than (or less than) said threshold t or a different predetermined, preconfigured or configured threshold t′, wherein
   the number/size/dimension of the time, frequency and/or spatial domain resources associated with said first subset is less than that of the said at least one other subset, and/or
   the difference/deviation in value of said parameter from the threshold t is higher (or lower) than that of said at least one other subset from its respective threshold, and/or
   the index/indicator/identifier of said first subset is higher/lower than that of said at least one other subset.

In certain embodiments, the wireless device is configured to
receive from a network node
   a configuration or indication of two or more subsets of time/frequency and/or spatial domain resources associated with a CSI-RS resource via the PHY-layer or a higher layer, wherein
      two or more groups of subsets are present, each group comprising one or more subsets, wherein subset(s) from a given group comprise/occupy/are associated with identical number of time, frequency and/or spatial resources,
      the number of resources associated/occupied by a subset of said first group is less than that of a subset of said second group, and the number of resources associated/occupied by a subset of said second group is less than that of a subset of a third group, if present, and so on,
report to a network node, at least an index/indicator/identifier of a subset associated with said CSI-RS resource from a group of subset(s), wherein.
   the value of said parameter computed for at least one of the subsets in said group is greater than (or less than) a first threshold value, and/or
   the group that the subset belongs to comprises/occupies/is associated with the least number of time/frequency and/or spatial domain resources among all the group(s) of subset(s) for which there is at least one subset whose value of said parameter is greater than (or less than) said first threshold value or a different threshold value.

In certain embodiments, the UE reports to the network node at least an index/indicator/identifier of a subset associated with said CSI-RS resource from a group of subset(s), wherein.
the value of said parameter computed for at least one of the subsets in said group is greater than (or less than) a first threshold value, and/or
the group that the subset belongs to comprises/occupies/is associated with the least number of time/frequency and/or spatial domain resources among all the group(s) of subset(s) for which there is at least one subset whose value of said parameter is greater than (or less than) said first threshold value or a different threshold value, and/or
the said subset has the highest or lowest difference from said threshold value among the subsets within the group that the subset belongs to.

In certain embodiments, each group of subset(s) or each subset associated with a CSI-RS resource may be configured or indicated with a separate threshold value via the PHY-layer or a higher layer, and the reported subset is based on the comparison with the threshold value configured/indicated for said subset or group of subset(s).

In certain embodiments, the wireless device measures, computes and/or reports to the network node via the PHY-layer or a higher layer, one or more parameters related to a channel state information, CSI, and/or DL transmission rate and/or reliability associated with one of the P subsets configured or indicated by the network node for a CSI-RS resource.

In some examples, the report may comprise at least the following:
an index/indicator/identifier of a subset associated with said CSI-RS resource,
at least one or more of the following parameters:
   channel quality index/indicator value(s),
   precoding matrix index/indicator information,
   rank indicator(s),
   layer indicator(s).

In some other examples, the report may comprise at least the following:
an index/indicator/identifier of a subset associated with said CSI-RS resource,
at least one or more of the following parameters:
   a performance/measurement metric,
   a differential or a relative performance/measurement metric with respect to the same metric computed in association with said CSI-RS resource.

In certain embodiments, said report may also comprise a CSI-RS resource indicator, CRI.

### Configuration and Acquisition of Subset-Based Information from Multiple CSI-RS Resources

In the above method, the UE receives configuration of a CSI-RS resource and one or more subsets, based on which the UE may provide a feedback on the best subset(s) to use for DL transmissions. In an alternative, the subsets configured in the above method may correspond to individual CSI-RS resources as well. With such a configuration, the UE may provide a report with respect to one or more said CSI-RS resources similar to a beam report so as to aid the network node in the subset selection. In another scenario, the UE may choose the subset by itself by reporting one CRI.

In certain embodiments, a method for wireless communications performed by a wireless device (user equipment) is proposed, the method comprising,
receiving at least a channel state information, CSI, report configuration, from a network node via a higher layer, wherein the CSI report configuration at least provides two or more CSI-RS resources for channel measurement by the wireless device wherein each CSI-RS resource is configured with one or more ports,
performing measurements on at least one of the said CSI-RS resources,
computing one or more parameters related to a channel state information, CSI, and/or DL transmission rate and/or reliability associated with at least one of the said CSI-RS resources, and
transmitting a report to the network node, via the PHY-layer or a higher layer, the report comprising at least one or more of said computed parameter(s) associated with at least one of the said CSI-RS resources.

In certain embodiments, the UE is configured with Q>2 CSI-RS resources for channel measurement.

In certain embodiments, said CSI report configuration provides one or more CSI-IM resources or ZP CSI-RS resources for interference measurement.

In certain embodiments, the reporting is performed using a CSI report, wherein the CSI report is transmitted by the wireless device on the physical uplink shared channel (PUSCH) or the physical uplink control channel (PUCCH).

In certain embodiments, the wireless device is configured to perform said reporting in response to/in association with a CSI report configuration. The reporting is performed via the PHY-layer and is transmitted on the PUSCH or the PUCCH.

In certain embodiments, the wireless device is configured to perform said reporting via a MAC-CE message or via the RRC layer.

In certain embodiments, the wireless device is configured to receive a higher layer configuration or an indication via a MAC-CE message or PHY-layer, a codebook configuration or at least one or more parameters associated with a codebook configuration for the measurement, computation and/or reporting of one or more parameters related to a CSI and/or DL transmission rate and/or reliability associated with at least one of the CSI-RS resources for channel measurement. In certain embodiments, the wireless device is configured to report to a network node via the PHY-layer or a higher layer, one or more parameters related to a CSI and/or DL transmission rate and/or reliability associated with R CSI-RS resources, wherein 1≤R ≤Q.

In certain embodiments, the UE is configured to measure, compute and/or report to a network node, at least one of the following parameters associated with one or more of the R CSI-RS resources:
wideband or subband CQI value(s)
precoding matrix indicator(s) or information related to precoding matrix indicator(s)
rank indicator
layer indicator

In certain embodiments, R=1.

In certain embodiments, the wireless device is configured to measure, compute and/or report to a network node via the PHY-layer or a higher layer, at least one of the following parameter(s) associated with at least one of the R CSI-RS resource(s), wherein 1≤R≤Q:
a performance/measurement metric,
a differential or a relative performance/measurement metric with respect to the same metric computed with respect to one of Q configured CSI-RS resources.

In certain embodiments, the performance/measurement metric and/or the differential/relative performance/measurement metric measured, computed and/or reported by a wireless device to a network node via the PHY-layer or a higher layer, with respect to one or more CSI-RS resources is at least one of the following:
a reference signal received power (RSRP) or a differential RSRP,
a signal to interference-plus-noise ratio (SINR) or a differential SINR,
an index/indicator of a modulation and coding scheme (MCS) or a differential MCS index/indicator,
a channel quality indicator/index, CQI, or a differential CQI,
a value/differential value (or an indicator of a value/differential value) of a throughput/spectral efficiency or any other parameter related to a data rate or reliability,
a rank or a differential rank value/indicator,
a BLER or a differential BLER value/indicator

In certain embodiments, the wireless device is configured to measure, compute and/or report at least two of the following parameters associated with one or more CSI-RS resources:
an index/indicator of a modulation and coding scheme (MCS) or a differential MCS index/indicator,
a channel quality indicator/index, CQI, or a differential CQI,
a rank or a differential rank value/indicator,
a BLER or a differential BLER value/indicator

In certain embodiments, the network node provides to the wireless device, via the PHY-layer of a higher layer, a configuration or indication of one or more parameter(s) related to a channel state information, CSI, and/or DL transmission rate and/or reliability associated with at least one CSI-RS resource, that the wireless device shall report.

In certain embodiments, the report provided by the wireless device may comprise at least the following:
The indices/indicators/identifiers of R CSI-RS resource(s), where 1≤R≤Q.
For each CSI-RS resource, one or more parameters related to a CSI and/or DL transmission rate and/or reliability associated with a physical downlink channel.

In certain embodiments, the same set of one or more parameters is/are reported for each of the K subsets reported by the wireless device.

In some examples, the report does not comprise a CRI, but it comprises one or more parameters related to a CSI and/or DL transmission rate and/or reliability associated with a CSI-RS resource. In such cases, the CSI report configuration associated with said report from the wireless device comprises just one CSI-RS resource for channel measurement.

In certain embodiments, the wireless device, for the computation and/or reporting of at least one parameter related to a CSI, DL transmission rate and/or reliability associated with a CSI-RS resource,
receives from the network node via the PHY-layer or a higher layer, at least one value of a threshold t, or
knows apriori (for e.g., predetermined/fixed in the specifications or known via UE implementation) at least one value of a threshold t.

In certain embodiments, the wireless device reports to a network node via the PHY-layer of a higher layer, at least an index/indicator/identifier of a CSI-RS resource, wherein the value of said at least one parameter associated with said resource is greater than (or less than) a threshold t.

With the above threshold set, a comparison with the threshold for the reported resource along with the comparison with other resources (in terms of the number of resources or an implementation based determination of subset size, for e.g., based on subset index) determines the reported subset at the UE.

In certain embodiments, the wireless device is configured to report to a network node, at least an index/indicator/identifier of a first CSI-RS resource, wherein at least one of the following conditions apply:
the value of said at least one parameter associated with said first CSI-RS resource is greater than (or less than) a threshold t,
the value of said at least one parameter associated with at least one other CSI-RS resource among the Q resources is greater than (or less than) the threshold t or a different predetermined, preconfigured or configured threshold t′, wherein
   the number/size/dimension of the time, frequency and/or spatial domain resources associated with said first CSI-RS resource is less than that of the said at least one other CSI-RS resource, and/or
   the difference/deviation in value of said parameter associated with said first CSI-RS resource from the threshold, is higher (or lower) than that of said at least one other CSI-RS resource from its respective threshold, and/or
   the index/indicator/identifier of said first CSI-RS resource is higher/lower than that of said at least one other CSI-RS resource.

In certain embodiments, M>1 subsets of CSI-RS resources among the Q channel measurement CSI-RS resources provided in a CSI report configuration are present, wherein the wireless device shall provide to a network node in a report, at least the index (indices)/indicator(s)/identifier(s) of 1≤L≤Q resources, wherein, when L≥2
at least one resource from each subset of resources is provided in the report, or
at least two of the resources provided in the report belong to two different subsets.

In certain embodiments, the UE reports one or more said parameters with respect to a CSI resource ‘X’ within a subset comprising two or more resources, wherein said resource ‘X’ performs the ‘best’ compared to the other resources in said subset with respect to one or more parameters related to a CSI and/or DL transmission rate and/or reliability. In some examples, the parameter(s) with respect to which the comparison of the performance is performed is/are at least one of the following: BLER, CQI, MCS, rank, throughput, spectral efficiency, RSRP and/or SINR.

### Enhancements to Beam mangement VIA DL RS Transmissions Configuring flexible number of beams to reported by the UE

In the following embodiments, an enhancement to the beam reporting by the UE based on measurements performed on received DL resources configured for beam management, e.g., CSI-RSs or SSBs, can be proposed. This means, enhancements to the P2 procedure introduced earlier that enables the gNB to better optimize its beams for energy efficiency by forming beams using a subset of elements from the antenna array.

Recall that in FR2 , the gNB and UE need to establish a connection via spatially selective or directive beams at both transmitter and receiver sides, employing a large number of antenna elements per virtual antenna port. Also recall that the gNB can save a lot of energy by minimizing the number of active antenna elements, however, in turn compromising on quality of beamforming or antenna gain in a given direction.

The gNB implementation is free to enable any possible subset of antenna elements (applicable to the given number of virtual antenna ports or CSI-RS ports) from the total available set during the beam sweeping steps. In order to enable the gNB to better select beams considering the tradeoff between the signal quality at the UEs and network energy saving, we propose to enhance the beam reporting signaling from the UEs based on CSI-RS based measurements.

In certain embodiments, a method for wireless communications performed by a wireless device (user equipment) is proposed, the method comprising,
receiving at least a channel state information report configuration from a network node via a higher layer, wherein the report configuration at least provides two or more CSI-RS and/or SSB resources for channel measurement by the wireless device,
performing measurements on at least one of the said resources, and
reporting the index (indices)/indicator(s)/identifier(s) of one or more RS(s) via the PHY-layer and/or a higher layer.

In certain embodiments, the reporting is performed via the PHY-layer on the PUSCH or the PUCCH. That is, the report is a CSI/beam report associated with the CSI report configuration.

In certain embodiments, the wireless device is provided with W≥2 CSI-RS/SSB resources for channel measurement.

In certain embodiments, the report comprises the index (indices)/indicator(s)/identifier(s) of L DL RS resource(s) (e.g., CRIs and/or SSBRIs), along with an L1-RSRP and/or L1-SINR value (or differential L1-RSRP and/or differential L1-SINR) associated with each resource, wherein 1≤L ≤W. In some examples, the value of L is configured by the network.

In certain embodiments, the wireless device is configured by a network node to report L ‘best’ beam(s)/resource(s) in terms of L1-RSRP and/or L1-SINR, i.e., the wireless device reports L beams/resources with the highest L1-RSRP and/or L1-SINR.

In certain embodiments, each RS among the L RS(s) reported by the wireless device is associated with a different RS or RS resource(s) for at least one quasi-colocation, QCL, type.

In certain embodiments, the wireless device uses different spatial receive filters or is indicated with different TCI states, to receive and/or measure at least two different RSs among the L reported RSs.

The benefits, in terms of network energy saving, are as follows:
The gNB is enabled to set CSI-RS resources needed for L1-RSRP and/or L1-SINR measurement and beam reporting from the UE across several DL Tx beams that can be formed not only in different spatial directions with a given set of antenna elements, but also multiple beams formed in each given direction (or close to it) using different reduced subsets of antenna elements.
To enable the gNB beam determination, the UE shall be configured to report more DL Tx beam indices and their respective L1-RSRP and/or L1-SINR values than what is presently possible, which is limited to up to 4 reports out of the several measurements performed on multiple received CSI-RS resources. Such an an enhancement to the beam reporting can improve the Tx beam refinement and/or energy optimization procedure by the gNB to select the best beam to serve a user with better consideration of the tradeoff between network energy saving and user performance.

### Configuring Flexible Subsets of DL RS Resources to the UE

In certain embodiments, M>1 subsets of the W>M CSI-RS resources are present, wherein the wireless device shall provide to a network node in a report, one or more index (indices)/indicator(s)/identifier(s) of CSI-RS resources, and one or more parameters related to RSRP or SINR measurements associated with said subset(s), wherein
at least one resource from each subset is provided in the report, or
at least two of the resources provided in the report belong to two different subsets.

In certain embodiments, said M>1 subsets of the set of W CSI-RS resources are configured by the network node.

In certain embodiments, said reporting on indices from said M>1 subsets is based on L1-RSRP and/or L1-SINR measurements performed on the W CSI-RS resources. The wireless device performs the measurements on said resources transmitted by the network node.

In certain embodiments, said reporting also includes the corresponding measured values of said L1-RSRP and/or L1-SINR measurements.

In certain embodiments, the wireless device is configured to receive an indication of a transmission configuration indication, TCI, state that comprises one or more DL/UL reference signals and one or more quasi-colocation types associated with them, for the reception and/or measurements of a CSI-RS resource.

In certain embodiments, the grouping of the W CSI-RS resource(s) into M subsets is performed by the wireless device or network node (or is a fixed method in the specifications) based on one or more common properties among the subsets.

In one example, the resources with identical number of time, frequency and/or spatial resources are included in the same subset.

In another example, the resources with the same TCI states are included in the same subset.

In a third example, the resources that share the same RS for deriving an Rx spatial filter (set via a QCL setting/TCI state indication for example) are included in the same group.

In certain embodiments, M>1 subsets of CSI-RS resources among the W channel measurement CSI-RS resources provided in a CSI report configuration are present, wherein the wireless device shall provide to a network node in a report, at least the index (indices)/indicator(s)/identifier(s) of 1≤L≤W resources, wherein, when L≥2
at least one resource from each subset of resources is provided in the report, or
at least two of the resources provided in the report belong to two different subsets.

A CSI-RS or SSB resource provided by a network node to a wireless device/measured by the wireless device, may correspond to a (downlink) beam, i.e., a Tx spatial filter or a spatial direction. Therefore, in this disclosure, the term ‘beam’ may be interchangeably used with a ‘resource’.

In certain embodiments, the wireless device is configured to report one or more parameters related to a CSI and/or DL transmission rate and/or reliability associated with said resource(s). In certain embodiments, the wireless device is configured to report a L1-SINR or L1-RSRP value (or a differential L1-SINR/RSRP value) associated with each resource provided in the report.

### Beam Downgrading Procedure and Associated Signaling

In other embodiments, a new procedure and associated enhanced beam reporting (“cri-RSRP” or in the case of SSB measurements “ssb-index-RSRP”) is proposed. Specifically, a possible beam downgrading procedure performed by the gNB is proposed through a novel reporting rule and configuration thereof. In this beam downgrading procedure, the gNB will configure CSI-RS resources for the UE measurement and an alternative rule for beam reporting in a network energy saving mode. Hereafter, for simplicity the beam downgrading procedure will be called “P4”. Typically, these CSI-RS resources will be associated with beams on the DL Tx direction or close to it, but using different number of spatial elements. In the reporting, however, the UE will not report the best beams (as in P2) but instead it will report bad/worse beams (lower/lowest RSRP/SINR) which are still above a certain RSRP/SINR threshold, which is set as part of the configuration. In essence, in P4 the gNB is trying to find a beam on a certain direction which is good enough. With that knowledge the gNB may take the decision to reduce the number of antenna elements and by how much this can be done. The candidate beams may be e.g. formed by varying the number of antenna elements.

In order to adapt back from few antenna elements to many antenna elements, selecting the best beam may be necessary. Here the P2 procedure and “cri-RSRP/SINR” can be fully reused. However, in order to have a single configuration which fits all adaptation, one may consider also a hybrid approach were both best beams and worst beams above a threshold are to be reported. In this case, the reporting order may depend on how many beams the UE is configured to report, e.g.:
Best beam is priority. If the UE is to report 1 beam, it will report the best beam. If it is to report 2 beams it will report the best beam and the worst beam above a threshold. If it is to report 4 beams it will report the two best beams and the two worst beams above a threshold.
Worst beam above a threshold is priority. If the UE is to report 1 beam, it will report the worst beam above a threshold. If it is to report 2 beams it will report the the worst beam above a threshold and the best beam. If it is to report 4 beams it will report the the two worst beams above a threshold and the two best beams.

This combined report may be controlled by more dynamic signaling (MAC CE or DCI) to simply change the number reported beams without changing the report configuration.

In certain embodiments, the wireless device is configured to report to the network node, via the PHY-layer and/or a higher layer, the index/indicator/identifier of L=1 CSI-RS or SSB resource, wherein the reported resource is one of the following:
The resource with the best L1-RSRP/SINR, among the W resources configured for measurement, or
The resource with the lowest L1-RSRP/SINR that is above a configured or predetermined/fixed threshold t, among the W resources configured for measurement.

In certain embodiments, the wireless device is configured to report to the network node, via the PHY-layer and/or a higher layer, indices/indicators/identifiers of L=2 CSI-RS or SSB resources, wherein the reported resources may be one of the following:
The resources with the highest and the lowest L1-RSRP/SINR, among the W resources configured for measurement, or
The resource with the highest L1-RSRP/SINR and the resource with the lowest L1-RSRP/SINR that is above a configured or predetermined/fixed threshold t, among the W resources configured for measurement.

In certain embodiments, the wireless device is configured to report to the network node, via the PHY-layer and/or a higher layer, indices/indicators/identifiers of L>2 CSI-RS or SSB resources, wherein the reported resources may be one of the following:
Z resource(s) with the highest and L-Z resource(s) with the lowest L1-RSRP/SINR, among the W resources configured for measurement, where 1≤Z<L, or
Z resource(s) with the highest L1-RSRP/SINR and L-Z resource(s) with the lowest L1-RSRP/SINR that is above a configured or predetermined/fixed threshold t, among the W resources configured for measurement, where 1≤Z<L.

### Configuring DL Beam Management VIA SRS Transmissions

In the following embodiments, an enhancement to the beam management through UL transmissions by the UE and measurements performed at gNB on received UL RS resources configured for beam management, e.g., SRS, can be proposed. This means, enhancements to the U2 procedure, previously described on “Beam Management” section, that enables the gNB to better optimize its beams for energy efficiency by forming beams using a subset of elements from the antenna array, e.g., based on SRS transmissions through fixed UE beam(s).

In certain embodiments, the UE can be configured by the network to transmit K UL RSs, e.g., SRSs, for beam management, wherein. the beam directions and/or spatial relation/direction for the UL RSs can either be selected by the UE, for example, based on measurements of DL RS(s), or
transmissions or UL RS(s), e.g., TCI-state or spatial relation of other UL RS(s) (which can be obtained from a UE sounding procedure such as U1), or a combination of both, and/or
K is configured or indicated by the network.

In certain embodiments, the network can schedule repetition of an SRS beam in order to sweep its Rx beams. The Rx beams may correspond to different sets of antenna elements and/or spatial directions.

Measurements (e.g., L1-RSRP/SINR) from the Rx beam sweep may help in assessing the link gains and determine an optimized beam at the network side. By performing UL beam sweeping instead of DL beam sweeping in the presence of beam correspondence at the UE and/or network node, the network may save energy and DL pilot overhead.

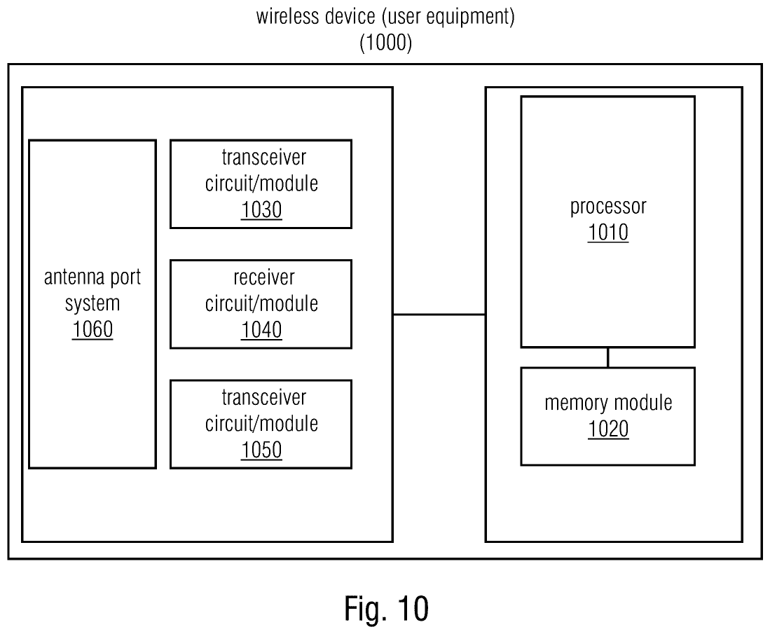

FIG. 10 illustrates a simplified block diagram depicting a wireless device or UE 1000 that carries out any of the aforementioned processes or method steps associated with a wireless device or UE. The wireless device 1000 comprises a processor 1010 or processing circuit or a processing module or a processor means 1010; a receiver circuit or receiver module 1040; a transmitter circuit or transmitter module 1050; a memory module 1020, a transceiver circuit or transceiver module 1030 which may include the transmitter circuit 1050 and the receiver circuit 1040. The wireless device 1000 further comprises an antenna system 1060 which includes antenna circuitry for transmitting and receiving signals to/from at least the network node or other wireless device(s). The antenna system employs beamforming as previously described.

The wireless device 1000 may belong to any radio access technology including 4G or LTE, LTE-A, 5G, advanced 5G or a combination thereof. They may additionally support beamforming technology. The wireless device comprising the processor and the memory contains instructions executable by the processor, whereby the wireless device 1000 is operative or is configured to perform any one of the embodiments related to the wireless device as previously described.

The processing module/circuit 1010 includes a processor, microprocessor, an application specific integrated circuit (ASIC), field programmable gate array (FPGA), or the like, and may be referred to as the “processor” The processor 1010 controls the operation of the wireless device and its components. Memory (circuit or module) 1020 includes a random-access memory (RAM), a read only memory (ROM), and/or another type of memory to store data and instructions that may be used by processor 1010. In general, it will be understood that the wireless device 1000 in one or more embodiments includes fixed or programmed circuitry that is configured to carry out the operations in any of the embodiments disclosed herein.

In at least one such example, the processor 1010 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 1000 may comprise additional components.

The wireless device 1000 by means of processor 1010 executes instructions contained in the memory 1020 whereby the wireless device is operative to perform any one of the previously described embodiments related to the actions performed by the wireless device, some of which are presented in the appended claims.

There is also provided a computer program comprising instructions which when executed by the processor 1010 of the wireless device cause the processor 1010 to carry out the method according to any one of the previously described embodiments.

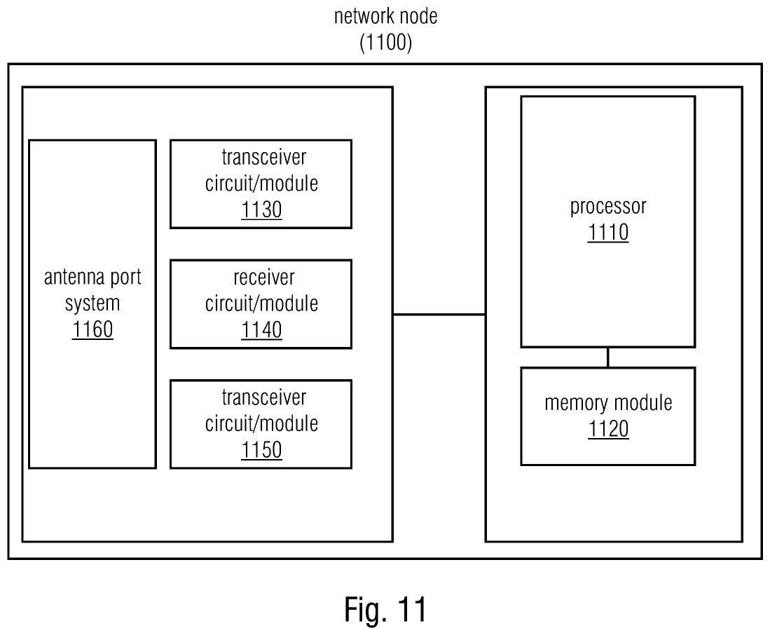

FIG. 11 illustrates a simplified block diagram depicting a network node 1100 that carries out any of the aforementioned processes or method steps associated with a network node. The network node 1100 comprises a processor 1110 or processing circuit or a processing module or a processor means 1110; a receiver circuit or receiver module 1140; a transmitter circuit or transmitter module 1150; a memory module 1120, a transceiver circuit or transceiver module 1130 which may include the transmitter circuit 1150 and the receiver circuit 1140. The network node 1100 further comprises an antenna system 1160 which includes antenna circuitry for transmitting and receiving signals to/from at least the wireless device. The antenna system may employ beamforming.

The network node 1100 may belong to any radio access technology including 4G or LTE, LTE-A, 5G, advanced 5G or a combination thereof that support beamforming technology. The network device comprising the processor and the memory contains instructions executable by the processor, whereby the network node 1100 is operative or is configured to perform any one of the embodiments related to the network node 1100 as previously described.

The processing module/circuit 1110 includes a processor, microprocessor, an application specific integrated circuit (ASIC), field programmable gate array (FPGA), or the like, and may be referred to as the “processor” The processor 1110 controls the operation of the network node and its components. Memory (circuit or module) 1120 includes a random-access memory (RAM), a read only memory (ROM), and/or another type of memory to store data and instructions that may be used by processor 1110. In general, it will be understood that the network node in one or more embodiments includes fixed or programmed circuitry that is configured to carry out the operations in any of the embodiments disclosed herein.

In at least one such example, the processor 1110 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 1100 may comprise additional components. The network node 1100 may also be viewed as a Transmitter and Receiver Point (TRP).

The network node 1100 by means of processor 1110 executes instructions contained in the memory 1120 whereby the network node 1100 is operative to perform any one of the previously described embodiments related to the actions performed by the network node, some of which are presented in the appended claims.

In the following, additional embodiments and aspects of the invention will be described which can be used individually or in combination with any of the features and functionalities and details described herein.

A first aspect relates to a user device, UE, for a wireless communication system, wherein the UE is configured to
receive from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the CSI report configuration,
perform measurement(s) on said at least one CSI-RS resource provided by the CSI report configuration,
compute one or more parameters related to a channel state information, CSI, and/or DL transmission rate and/or reliability associated with at least one of the P subsets of a CSI-RS resource configured or indicated by the network node, and
transmit a report to the network node via the PHY-layer or a higher layer, the report comprising at least one or more of said computed one or more parameter(s), which is/are associated with at least one of the P subsets of a CSI-RS resource configured or indicated by the network node.

According to a second aspect when referring back to the first aspect, in the UE,
the spatial domain resource(s) associated with a CSI-RS resource, is/are the port(s) associated with the CSI-RS resource, and/or
the frequency domain resource(s) associated with a CSI-RS resource, is/are the physical resource block(s) associated with the CSI-RS resource, and/or
the time domain resource(s) associated with a CSI-RS resource, is/are the symbols(s) associated with the CSI-RS resource in a slot/subframe/frame.

According to a third aspect when referring back to the first or second aspect, said CSI report configuration provides at least one of the following:
One or more non-zero power (NZP) CSI-RS resources for channel measurement,
One or more zero power (ZP) CSI-RS resources for interference measurement,
One or more CSI-Interference management (CSI-IM) resources for interference measurement,
One or more NZP CSI-RS resources for interference measurement.

According to a fourth aspect when referring back to any of the first to third aspects, said CSI report configuration provides at least a configuration or indication of P≥1 subset(s) of time, frequency and/or spatial domain resource(s) and/or parameter(s) related to them, associated with at least one of the CSI-RS resource(s).

According to a fifth aspect when referring back to any of the first to fourth aspects, the network nodes provide to the UE, via the PHY-layer or a higher layer, an indication or configuration of at least one of the following:
a parameter enabling the UE to choose to report a given subset pᵢ among the P subset(s) of a CSI-RS resource along with one or more parameter(s),
a parameter enabling to compute of one or more parameter(s) related to a CSI and/or DL transmission and/or DL transmission rate and/or reliability associated with subset pᵢ,
threshold for a parameter related to a CSI, DL transmission rate and/or reliability.

According to a sixth aspect when referring back to any of the first to fifth aspects, UE according to one of the previous claims, wherein the network nodes provides to the UE, via the PHY-layer or a higher layer, a configuration or indication of one or more parameter(s) related to a channel state information, CSI, and/or DL transmission rate and/or reliability associated with at least one of the subsets of a CSI-RS resource, that the UE shall measure, compute and/or report.

According to a seventh aspect when referring back to any of the first to sixth aspects, the reporting to the network node is performed via the physical uplink control channel, PUCCH, or the physical uplink shared channel, PUSCH.

According to an eighth aspect when referring back to any of the first to seventh aspects, one or more parameters related to a CSI and/or DL transmission rate and/or reliability associated with K subsets of the CSI-RS resource, wherein 1≤K≤P; and the value of K is configured by the network node, and/or equal to P, and/or fixed in the specifications.

According to a ninth aspect when referring back to any of the first to eighth aspects, the UE is configured to measure, compute and/or report to a network node, at least one of the following parameters associated with one or more of the K subsets associated with a CSI-RS resource:
wideband or subband CQI value(s)
precoding matrix indicator(s) or information related to precoding matrix indicator(s)
rank indicator
layer indicator

According to a tenth aspect when referring back to any of the first to ninth aspects, the reporting comprises at least one of the following parameter(s) associated with at least one of the K subsets of a CSI-RS resource, wherein 1≤K≤P:
a performance/measurement metric,
a differential or a relative performance/measurement metric with respect to the same metric computed in association with said CSI-RS resource,
a differential or a relative performance/measurement metric with respect to the same metric computed in association with one of the P subsets associated with said CSI-RS resource.

According to an eleventh aspect when referring back to any of the first to tenth aspects, the performance/measurement metric and/or the differential/relative performance/measurement metric reported by a wireless device to a network node via the PHY-layer or a higher layer, with respect to one or more subsets associated with a CSI-RS resource is at least one of the following:
a reference signal received power (RSRP) or a differential RSRP,
a signal to interference-plus-noise ratio (SINR) or a differential SINR,
an index/indicator of a modulation and coding scheme (MCS) or a differential MCS index/indicator,
a channel quality indicator/index, CQI, or a differential CQI,
a value/differential value (or an indicator of a value/differential value) of a throughput/spectral efficiency or any other parameter related to a data rate or reliability,
a rank or a differential rank value/indicator,
a BLER or a differential BLER value/indicator.

According to a twelfth aspect when referring back to any of the first to eleventh aspects, the UE is configured to report to a network node, at least an index/indicator/identifier of a first subset associated with a CSI-RS resource, wherein at least one of the following conditions apply:
the value of said at least one parameter associated with said first subset is greater than (or less than) a predetermined, preconfigured or configured threshold t,
the value of said at least one parameter associated with at least one other subset among the P subsets associated with the CSI-RS resource is greater than (or less than) said threshold t or a different predetermined, preconfigured or configured threshold t′, wherein
   the number/size/dimension of the time, frequency and/or spatial domain resources associated with said first subset is less than that of said at least one other subset, and/or
   the difference/deviation in value of said parameter from the threshold t is higher (or lower) than that of said at least one other subset from its respective threshold, and/or
   the index/indicator/identifier of said first subset is higher/lower than that of said at least one other subset.

According to a thirteenth aspect when referring back to any of the first to twelfth aspects, M>1 groups of said P subsets of a CSI-RS resource are present, wherein the UE shall provide to a network node in a report, one or more parameters related to a CSI and/or DL transmission rate and/or reliability associated with 1≤K≤P subsets of a CSI-RS resource, wherein among the K subset(s), when K≥2
at least two of the subsets belong to two different groups, or
every subset belongs to a different group.

A fourteenth aspect relates to a user device, UE, for a wireless communication system, wherein the UE is configured to
receive at least a CSI report configuration from a network node via a higher layer, wherein the CSI report configuration at least provides two or more CSI-RS resources for channel measurement by the wireless device wherein each CSI-RS resource is configured with one or more ports,
perform measurements on at least one or two of said CSI-RS resources,
compute one or more parameters related to a channel state information, CSI, and/or DL transmission rate and/or reliability associated with at least one of said CSI-RS resources, and
transmit a report to the network node via the PHY-layer or a higher layer, the report comprising at least one or more of said computed parameters associated with at least one of said CSI-RS resources.

According to a fifteenth aspect when referring back to the fourteenth aspect, the UE is configured with Q>2 CSI-RS resources for channel measurement.

According to a sixteenth aspect when referring back to the fourteenth or fifteenth aspect, the report provided by the UE may comprise at least the following:
The indices/indicators/identifiers of R CSI-RS resource(s), where 1≤R≤Q.
For each CSI-RS resource, one or more parameters related to a CSI and/or DL transmission rate and/or reliability associated with a physical downlink channel.

According to a seventeenth aspect when referring back to any of the fourteenth to sixteenth aspects, the UE is configured to report to a network node, at least an index/indicator/identifier of a first CSI-RS resource, wherein at least one of the following conditions apply:
the value of said at least one parameter associated with said first CSI-RS resource is greater than (or less than) a threshold t,
the value of said at least one parameter associated with at least one other CSI-RS resource among the Q resources is greater than (or less than) the threshold t or a different predetermined, preconfigured or configured threshold t′, wherein.
   the number/size/dimension of the time, frequency and/or spatial domain resources associated with said first CSI-RS resource is less than that of the said at least one other CSI-RS resource, and/or
   the difference/deviation in value of said parameter associated with said first CSI-RS resource from the threshold, is higher (or lower) than that of said at least one other CSI-RS resource from its respective threshold, and/or
   the index/indicator/identifier of said first CSI-RS resource is higher/lower than that of said at least one other CSI-RS resource.

According to an eighteenth aspect when referring back to any of the fourteenth to sixteenth aspects, M>1 subsets of CSI-RS resources among the Q channel measurement CSI-RS resources provided in a CSI report configuration are present, wherein the wireless device shall provide to a network node in a report, at least the index (indices)/indicator(s)/identifier(s) of 1≤L≤Q resources, wherein, when L≥2
at least one resource from each subset of resources is provided in the report, or
at least two of the resources provided in the report belong to two different subsets.

A nineteenth aspect relates to a user device, UE, for a wireless communication system, wherein the UE is configured to
receive at least a CSI report configuration from a network node via a higher layer, wherein the CSI report configuration at least provides W≥2 CSI-RS and/or SSB resources for channel measurement by the wireless device,
perform measurements on at least one of said resources, and
report the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

According to a twentieth aspect when referring back to the nineteenth aspect, the UE uses different spatial receive filters or is indicated with different, transmission configuration indication, TCI, states, to receive and/or measure at least two different RSs among the L reported RSs.

According to a twenty-first aspect when referring back to the nineteenth or twentieth aspect, M>1 subsets of said W>M CSI-RS resources are present, wherein the wireless device shall transmit to a network node in a report, one or more index (indices)/indicator(s)/identifier(s) of CSI-RS resources, and one or more parameters related to RSRP or SINR measurements associated with said subset(s), wherein
at least one resource from each subset is provided in the report, or
at least two of the resources provided in the report belong to two different subsets.

According to a twenty-second aspect when referring back to the twenty-first aspect, said grouping of the W CSI-RS resource(s) into M subsets is performed by the UE or network node or is a fixed method in the specifications, based on one or more common properties among the subsets.

According to a twenty-third aspect when referring back to any of the nineteenth to twenty-second aspects, the UE is configured to report to the network node, via the PHY-layer and/or a higher layer, the index/indicator/identifier of L=1 CSI-RS or SSB resource, wherein the reported resource is one of the following:
resource with the best L1-RSRP/SINR, among the W resources configured for measurement, or
resource with the lowest L1-RSRP/SINR that is above a configured or predetermined/fixed threshold t, among the W resources configured for measurement.

According to a twenty-fourth aspect when referring back to any of the nineteenth to twenty-third aspects, the UE is configured to report to the network node, via the PHY-layer and/or a higher layer, indices/indicators/identifiers of L≥2 CSI-RS or SSB resources, wherein the reported resources may be one of the following:
Z resource(s) with the highest and L-Z resource(s) with the lowest L1-RSRP/SINR, among the W resources configured for measurement, where 1≤Z<L, or
Z resource(s) with the highest L1-RSRP/SINR and L-Z resource(s) with the lowest L1-RSRP/SINR that is above a configured or predetermined/fixed threshold t, among the W resources configured for measurement, where 1≤Z<L.

A twenty-fifth aspect relates to a user device, UE, for a wireless communication system, wherein the UE is configured by a network to transmit K UL RSs, e.g., sounding reference signals, SRSs, for beam management, wherein.
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network.

According to a twenty-sixth aspect when referring back to the twenty-fifth aspect, in the UE,
the network schedules repetition of an SRS beam in order to sweep its Rx beams, and/or
the receive beams correspond to different sets of antenna elements and/or spatial directions.

A twenty-seventh aspect relates to a network node for a wireless communication system, the wireless communication system comprising one or more user devices, UEs, wherein the network node is configured to
transmit to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the CSI report configuration, and
enable the UE to
   perform measurements on said at least one CSI-RS resource provided by the CSI report configuration,
   compute one or more parameters related to a channel state information, CSI, and/or DL transmission rate and/or reliability associated with at least one of the P subsets of a CSI-RS resource configured or indicated by the network node, and
receive from the UE, a report via the PHY-layer or a higher layer, the report comprising at least one or more of said computed one or more parameter(s) which is/are associated with at least one of the P subsets of a CSI-RS resource configured or indicated by the network node.

A twenty-eighth aspect relates to a network node for a wireless communication system, the wireless communication system comprising one or more user devices, UEs, wherein the network node is configured to
transmit to a UE at least a CSI report configuration from a network node via a higher layer, wherein the CSI report configuration at least provides two or more CSI-RS resources for channel measurement by the wireless device wherein each CSI-RS resource is configured with one or more ports, and
enable the UE to
   perform measurements on at least one or two of said CSI-RS resources, and
   compute one or more parameters related to a channel state information, CSI, and/or DL transmission rate and/or reliability associated with at least one of said CSI-RS resources, and
receive from the UE, a report via the PHY-layer or a higher layer, the report comprising at least one or more of said computed parameters associated with at least one of said CSI-RS resources.

A twenty-ninth aspect relates to a network node for a wireless communication system, the wireless communication system comprising one or more user devices, UEs, wherein the network node is configured to
transmit to the UE at least a CSI report configuration from a network node via a higher layer, wherein the CSI report configuration at least provides W≥2 CSI-RS and/or SSB resources for channel measurement by the wireless device, and
enabled the UE to perform measurements on at least one of said resources, and
receive from the UE, a report of the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

A thirtieth aspect relates to a network node for a wireless communication system, the wireless communication system comprising one or more user devices, UEs, wherein the network node is to configure a UE to transmit K UL RSs, e.g., sounding reference signals, SRSs, for beam management, wherein
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network node.

A thirty-first aspect relates to a system comprising a BS according to one of the twenty-seventh to thirtieth aspects and a UE according to one of the first to twenty-sixth aspects.

A thirty-second aspect relates to a method for operating a user device, UE, for a wireless communication system, the method comprising
receiving from a network node, e.g., gNB, at least
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P>1 subset(s) of time, frequency and/or spatial domain resource(s) and/or parameter(s) related to them, associated with at least one of the CSI-RS resources provided by the CSI report configuration, performing measurements on said at least one CSI-RS resource provided by the CSI report configuration,
computing one or more parameters related to a channel state information, CSI, and/or DL transmission rate and/or reliability associated with at least one of the P subsets of a CSI-RS resource configured or indicated by the network node, and
transmitting a report to the network node via the PHY-layer or a higher layer, the report comprising at least one or more of the computed parameter(s) associated with at least one of the P subsets of a CSI-RS resource configured or indicated by the network node.

A thirty-third aspect relates to a method for operating a user device, UE, for a wireless communication system, the method comprising
receiving at least a channel state information CSI report configuration from a network node via a higher layer, wherein the CSI report configuration at least provides two or more CSI-RS resources for channel measurement by the wireless device wherein each CSI-RS resource is configured with one or more ports,
performing measurements on at least one of said CSI-RS resources,
computing one or more parameters related to a channel state information, CSI, and/or DL transmission rate and/or reliability associated with at least one of said CSI-RS resources, and
transmitting a report to the network node via the PHY-layer or a higher layer, the report comprising at least one or more of said computed one or more parameters which is/areassociated with at least one of said CSI-RS resources.

A thirty-fourth aspect relates to a method for operating a user device, UE, for a wireless communication system, the method comprising:
receiving at least a CSI report configuration from a network node via a higher layer, wherein the CSI report configuration at least provides W≥2 CSI-RS and/or SSB resources for channel measurement by the wireless device,
performing measurements on at least one of said resources, and
reporting the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

A thirty-fifth aspect relates to a method for operating a user device, UE, for a wireless communication system, the method comprising, receiving configuration from the network to transmit K UL RSs, e.g., sounding reference signals, SRSs, for beam management, wherein
the beam directions and/or spatial relation/direction for the UL RSs can either be selected by the UE, for example, based on measurements of DL RS(s), or
transmissions or UL RS(s), e.g., TCI-state or spatial relation of other UL RS(s) (which can be obtained from a UE sounding procedure such as U1), or a combination of both, and
K is configured or indicated by the network.

A thirty-sixth aspect relates to a method for operating a network node for a wireless communication system, the wireless communication system comprising one or more user devices, UEs, the method comprising
transmitting to a UE
   a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
   a configuration or indication via a PHY-layer, e.g., physical downlink control channel, PDCCH, signalling, and/or a higher layer, e.g., RRC or medium access control, MAC, layer signalling, P≥1 subset(s) of time, frequency and/or spatial domain resource(s) and/or parameter(s) related to them, associated with at least one of the CSI-RS resources provided by the CSI report configuration, and
enabling the UE to
   perform measurements on said at least one CSI-RS resource provided by the CSI report configuration,
   compute one or more parameters related to a channel state information, CSI, and/or DL transmission rate and/or reliability associated with at least one of the P subsets of a CSI-RS resource configured or indicated by the network node, and
receiving from the UE, a report via the PHY-layer or a higher layer, the report comprising at least one or more of the computed parameter(s) associated with at least one of the P subsets of a CSI-RS resource configured or indicated by the network node.

A thirty-seventh aspect relates to a method for operating a network node for a wireless communication system, the wireless communication system comprising one or more user devices, UEs, the method comprising
transmitting to a UE at least a channel state information CSI report configuration from a network node via a higher layer, wherein the CSI report configuration at least provides two or more CSI-RS resources for channel measurement by the wireless device wherein each CSI-RS resource is configured with one or more ports, and
enabling the UE to
   perform measurements on at least one of said CSI-RS resources, and
   compute one or more parameters related to a channel state information, CSI, and/or DL transmission rate and/or reliability associated with at least one of said CSI-RS resources, and
receiving from the UE, a report via the PHY-layer or a higher layer, the report comprising at least one or more of said computed parameters associated with at least one of said CSI-RS resources.

A thirty-eighth aspect relates to a method for operating a network node for a wireless communication system, the wireless communication system comprising one or more user devices, UEs, the method comprising
transmitting to the UE at least a CSI report configuration from a network node via a higher layer, wherein the CSI report configuration at least provides W≥2 CSI-RS and/or SSB resources for channel measurement by the wireless device, and
enabling the UE to perform measurements on at least one of said resources, and
receiving from the UE, a report of the index (indices)/indicator(s)/identifier(s) of L RS(s) via the PHY-layer and/or a higher layer along with an L1-RSRP and/or L1-SINR value (or differential L1-RSRP and/or differential L1-SINR) associated with each resource, wherein 1≤L≤W, and the value L is configured by the network.

A thirty-ninth aspect relates to a method for operating a network node for a wireless communication system, the wireless communication system comprising one or more user devices, UEs, the method comprising, configuring a UE to transmit K UL RSs, e.g., sounding reference signals, SRSs, for beam management, wherein
the beam directions and/or spatial relation/direction for the UL RSs can either be selected by the UE, for example, based on measurements of DL RS(s), or transmissions or UL RS(s), e.g., TCI-state or spatial relation of other UL RS(s) (which can be obtained from a UE sounding procedure such as U1), or a combination of both, and
K is configured or indicated by the network node.

A fortieth aspect relates to a computer program for performing the steps of the methods according to any one of the thirty-second to thirty-ninth aspects.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] 3GPP TS 38.101-1 V17.3.0: “3GPP; TSG RAN; User Equipment (UE) radio transmission and reception; Part 1: Range 1 Standalone,” Oct. 2021.

1. A user device, UE, for a wireless communication system, wherein the UE is configured to
receive from a network node, e.g., gNB, at least
a channel state information, CSI, report configuration via a higher layer, e.g., racio resource control, RRO, layer, wherein the CSI report configuration provides at least one CSI reference signal, CSI-RS, resource comprising N>1 ports for measurement by the UE,
a configuration or indication via a PHY-layer, e.g., physical downlink control channel, PDC signalling, or a higher layer, e.g., ARC or medium access control, MAC, layer na ng, P≥1 subset(s) of spatial domain resource(s) or parameter(s) related to them, associated with at least one of the CSI-RS resources provided by the CSI report configuration,
perform measurement(s) on said at least one CSI-RS resource provided by the CSI report configuration,
compute one or more parameters related to a channel state information, CSI, or DL transmission rate or reliability associated with at least one of the P subsets of a CSI-RS resource configured or indicated by the network node, and
transmit a report to the network node via the PHY-layer or a higher layer, the report comprising at least one or more of said computed one or more parameter(s), which is/are associated with at least one of the P subsets of a CSI-RS resource configured or indicated by the network node.

1. UE according to claim 1, wherein,
the spatial domain resource(s) associated with a CSI-RS resource, is/are the port(s) associated with the CSI-RS resource, and/or
the frequency domain resource(s) associated with a CSI-RS resource, is/are the physical resource block(s) associated with the CSI-RS resource, and/or
the time domain resource(s) associated with a CSI-RS resource, is/are the symbols(s) associated with the CSI-RS resource in a slot/subframe/frame.

2. UE according to claim 1, wherein said CSI report configuration provides at least one of the following:
One or more non-zero power (NZP) CSI-RS resources for channel measurement,
One or more zero power (ZP) CSI-RS resources for interference measurement,
One or more CSI-Interference management (CSI-IM) resources for interference. measurement,
One or more NZP CSI-RS resources for interference measurement.

3. UE according to claim 1, wherein said CSI report configuration provides at least a configuration or indication of P≥1 subset(s) of spatial domain resource(s) or parameter(s) related to them, associated with at least one of the CSI-RS resource(s).

4. UE according to claim 1, wherein the network nodes provide to the UE, via the PHY-layer or a higher layer, an indication or configuration of at least one of the following:
a parameter enabling the UE to choose to report a given subset pi among the P subset(s) of a CSI-RS resource along with one or more parameter(s),
a parameter enabling to compute of one or more parameter(s) related to a CSI or DL transmission or DL transmission rate or reliability associated with subset pi,
threshold for a parameter related to a CSI, DL transmission rate or reliability.

5. UE according to claim 1, wherein the network nodes provides to the UE, via the PHY-layer or a higher layer, a configuration or indication of one or more parameter(s) related to a channel state information, CSI, or DL transmission rate or reliability associated with at least one of the subsets of a CSI-RS resource, that the UE is to measure, compute and/or report.

6. UE according to claim 1, wherein the reporting to the network node is performed via the physical uplink control channel, PUCCH, or the physical uplink shared channel, PUSCH.

7. UE according to claim 1, wherein one or more parameters related to a CSI or DL transmission rate or reliability associated with K subsets of the CSI-RS resource, wherein 1≤K≤P; and the value of K is configured by the network node, or equal to P, or fixed in the specifications.

8. UE according to claim 1, wherein the UE is configured to measure, compute and/or report to a network node, at least one of the following parameters associated with one or more of the K subsets associated with a CSI-RS resource:
wideband or subband CQI value(s)
precoding matrix indicator(s) or information related to precoding matrix indicator(s)
rank indicator
layer indicator

9. UE according to claim 1, wherein the reporting comprises at least one of the following parameter(s) associated with at least one of the K subsets of a CSI-RS resource, wherein 1≤K≤P:
a performance/measurement metric,
a differential or a relative performance/measurement metric with respect to the same metric computed in association with said CSI-RS resource,
a differential or a relative performance/measurement metric with respect to the same metric computed in association with one of the P subsets associated with said CSI-RS resource.

10. UE according to claim 1, wherein the performance/measurement metric or the differential/relative performance/measurement metric reported by a wireless device to a network node via the PHY-layer or a higher layer, with respect to one or more subsets associated with a CSI-RS resource is at least one of the following:
a reference signal received power (RSRP) or a differential RSRP,
a signal to interference-plus-noise ratio (SINR) or a differential SINR,
an index/indicator of a modulation and coding scheme (MCS) or a differential MCS index/indicator,
a channel quality indicator/index, CQI, or a differential CQI,
a value/differential value (or an indicator of a value/differential value) of a throughput/spectral efficiency or any other parameter related to a data rate or reliability,
a rank or a differential rank value/indicator,
a BLER or a differential BLER value/indicator

11. A network node for a wireless communication system, the wireless communication system comprising one or more user devices, UEs, wherein the network node is configured to
a. transmit to a UE
a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration, and
enable the UE to
perform measurements on said at least one CSI-RS resource provided by the CSI report configuration,
compute one or more parameters related to a channel state information, CSI, or DL transmission rate or reliability associated with at least one of the P subsets of a CSI-RS resource configured or indicated by the network node, and
receive from the UE, a report via the PHY-layer or a higher layer, the report comprising at least one or more of said computed one or more parameter(s) which is/are associated with at least one of the P subsets of a CSI-RS resource configured or indicated by the network node.

12. A method for operating a user device, UE, for a wireless communication system, the method comprising
receiving from a network node, e.g., gNB, at least
a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration,
performing measurements on said at least one CSI-RS resource provided by the CSI report configuration,
computing one or more parameters related to a channel state information, CSI, or DL transmission rate or reliability associated with at least one of the P subsets of a CSI-RS resource configured or indicated by the network node, and
transmitting a report to the network node via the PHY-layer or a higher layer, the report comprising at least one or more of the computed parameter(s) associated with at least one of the P subsets of a CSI-RS resource configured or indicated by the network node.

13. A method for operating a network node for a wireless communication system, the wireless communication system comprising one or more user devices, UEs, the method comprising
a. transmitting to a UE
a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration, and
enabling the UE to
perform measurements on said at least one CSI-RS resource provided by the CSI report configuration,
compute one or more parameters related to a channel state information, CSI, or DL transmission rate or reliability associated with at least one of the P subsets of a CSI-RS resource configured or indicated by the network node, and
receiving from the UE, a report via the PHY-layer or a higher layer, the report comprising at least one or more of the computed parameter(s) associated with at least one of the P subsets of a CSI-RS resource configured or indicated by the network node.

14. A non-transitory digital storage medium having a computer program stored thereon to perform the method for operating a user device, UE, for a wireless communication system, the method comprising
receiving from a network node, e.g., gNB, at least
a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration,
performing measurements on said at least one CSI-RS resource provided by the CSI report configuration,
computing one or more parameters related to a channel state information, CSI, or DL transmission rate or reliability associated with at least one of the P subsets of a CSI-RS resource configured or indicated by the network node, and
transmitting a report to the network node via the PHY-layer or a higher layer, the report comprising at least one or more of the computed parameter(s) associated with at least one of the P subsets of a CSI-RS resource configured or indicated by the network node,
when said computer program is run by a computer.

15. A non-transitory digital storage medium having a computer program stored thereon to perform the method for operating a network node for a wireless communication system, the wireless communication system comprising one or more user devices, UEs, the method comprising
a. transmitting to a UE
a channel state information, CSI, report configuration via a higher layer, e.g., radio resource control, RRC, layer, wherein the CSI report configuration provides at least one CSI reference signal, CSI-RS, resource comprising N>1 ports for measurement by the UE,
a configuration or indication via a PHY-layer, e.g., physical downlink control channel, PDCCH, signalling, or a higher layer, e.g., RRC or medium access control, MAC, layer signalling, P≥1 subset(s) of spatial domain resource(s) or parameter(s) related to them, associated with at least one of the CSI-RS resources provided by the CSI report configuration, and
enabling the UE to
perform measurements on said at least one CSI-RS resource provided by the CSI report configuration,
compute one or more parameters related to a channel state information, CSI, or DL transmission rate or reliability associated with at least one of the P subsets of a CSI-RS resource configured or indicated by the network node, and
receiving from the UE, a report via the PHY-layer or a higher layer, the report comprising at least one or more of the computed parameter(s) associated with at least one of the P subsets of a CSI-RS resource configured or indicated by the network node,
when said computer program is run by a computer.
